(19) United States
(12) Patent Application Publication
(10) Pub. No.: US 2026/0222256 A1
(43) Pub. Date: Jul. 30, 2026

(54) WIRELESS MEDIA DEVICE AND IMAGE DISPLAY DEVICE PROVIDED WITH SAME

(71) Applicant: LG ELECTRONICS INC., Seoul (KR)

(72) Inventor: Chijun AHN, Seoul (KR)

(73) Assignee: LG ELECTRONICS INC., Seoul (KR)

(21) Appl. No.: 19/143,346

(22) PCT Filed: Mar. 16, 2023
(86) PCT No.: PCT/KR2023/003503

§ 371 Date: Jun. 25, 2025

(30) Foreign Application Priority Data
Dec. 26, 2022 (KR) 10-2022-0184400

(51) Int. Cl. H04L 27/26; H04J 11/00

(52) U.S. Cl. CPC H04L 27/26035; H04J 11/0023

(57) ABSTRACT

A wireless media device according to an embodiment of the present disclosure includes: a signal processing device configured to process an image signal or an audio signal; and a transceiver configured to wirelessly transmit a signal from the signal processing device to an external display device, and the transceiver is configured to transmit, to the display device, a data frame including a preamble, a header, and media data through at least one transmission channel among a plurality of channels, and control a preamble of a channel adjacent to the transmission channel, and a preamble of the transmissions channel to be different from or orthogonal to each other. Accordingly, it is possible to reduce channel interference of adjacent channels during the wireless media transmission.

### BACKGROUND

### 1. Field

The present disclosure relates to an image display apparatus, and more particularly, to an image display apparatus capable of reducing channel interference of an adjacent channel during wireless media transmission.

### 2. Description of the Related Art

Image display apparatuses display images through displays.

Meanwhile, sound can be output through an audio output device in addition to an image through image display apparatuses.

Meanwhile, in order to output image on the displays of the image display apparatuses, a signal processing device performs image signal processing and the like.

Recently, for ease of use, a method of separating a display and a signal processing device in an image display apparatus and performing media transmission between the display and the signal processing device by a wireless communication method rather than a wired communication method has been studied.

Meanwhile, when media is transmitted by a wireless communication scheme, some channels among a plurality of channels are used. Meanwhile, when some channels are used, there is a possibility that channel interference will occur in adjacent channels.

Meanwhile, when the channel interference occurs in a wireless channel environment, an error occurrence possibility increases, and there is a problem in that a broken screen is displayed or pop noise or the like is output when an error occurs.

### SUMMARY

An object of the present disclosure is to provide a wireless media device, and an image display apparatus including the same, which are capable of reducing channel interference of an adjacent channel during wireless media transmission.

Another object of the present disclosure is to provide a wireless media device, and an image display apparatus including the same, which are capable of stably transmitting media data during wireless media transmission.

A wireless media device according to an embodiment of the present disclosure includes: a signal processing device configured to process an image signal or an audio signal; and a transceiver configured to wirelessly transmit a signal from the signal processing device to an external display device, and the transceiver is configured to transmit, to the display device, a data frame including a preamble, a header, and media data through at least one transmission channel among a plurality of channels, and control a preamble of a channel adjacent to the transmission channel, and a preamble of the transmissions channel to be different from or orthogonal to each other.

Meanwhile, the transceiver can be configured to control the preamble of the channel adjacent to the transmission channel, and the preamble of the transmission channel to be different from or orthogonal to each other during a data transfer period of transmitting the media data to the display device.

Meanwhile, the transceiver can be configured to transmit a data frame including a legacy-short training field (L-STF), a legacy-channel estimation field (L-CEF), a legacy (L)-header, and the media data when a non-enhanced directional multi-gigabit PHY protocol data unit (EDMG PPDU)-based data frame is transmitted through the transmission channel among the plurality of channels during the data transfer period, and control an L-STF in the preamble of the transmission channel to be different from or orthogonal to an L-STF in the preamble of the channel adjacent to the transmission channel.

Meanwhile, the transceiver can be configured to transmit a data frame including the legacy-short training field (L-STF), the legacy-channel estimation field (L-CEF), the legacy (L)-header, an EDMG (E)-header, and the media data when an EDMG PPDU-based data frame is transmitted through the transmission channel among the plurality of channels during the data transfer period, and control the L-STF in the preamble of the transmission channel to be different from or orthogonal to the L-STF in the preamble of the channel adjacent to the transmission channel.

Meanwhile, the EDMG PPDU-based data frame can further include an EDMG-short training field (E-STF) and an EDMG-channel estimation field (E-CEF).

Meanwhile, the transceiver can be configured to transmit a first data frame including the media data through a first channel among the plurality of channels during the data transfer period, and control a preamble of each of a second channel and a third channel adjacent to the first channel, and the preamble of the first channel to be different from or orthogonal to each other.

Meanwhile, the transceiver can be configured to transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel among the plurality of channels during the data transfer period, and control an L-STF in the preamble of the first channel to be different from or orthogonal to L-STFs in the preambles of the second channel and the third channel adjacent to the first channel.

Meanwhile, the transceiver can be configured to transmit the data frame including the legacy-short training field (L-STF), the legacy-channel estimation field (L-CEF), the legacy (L)-header, an EDMG (E)-header, and the media data when the EDMG PPDU-based data frame is transmitted through the first channel among the plurality of channels during the data transfer period, and control the L-STF in the preamble of the first channel to be different from or orthogonal to the L-STF in the preamble of the channel adjacent to the first channel.

Meanwhile, the transceiver can be configured to transmit a first data and a second data frame including the media data through the first channel and the second channel among the plurality of channels during the data transfer period, and control a preamble of a third channel adjacent to the first channel to be different from or orthogonal to the preamble of the first channel, and control a preamble of a fourth channel adjacent to the second channel to be different from or orthogonal to the preamble of the second channel.

Meanwhile, the transceiver can be configured to transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel and the second channel among the plurality of channels during the data transfer period, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel.

Meanwhile, the transceiver can be configured to transmit the data frame including the legacy-short training field (L-STF), the legacy-channel estimation field (L-CEF), the legacy (L)-header, an EDMG (E)-header, and the media data when the EDMG PPDU-based data frame is transmitted through the first channel among the plurality of channels during the data transfer period, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel.

Meanwhile, the transceiver can be configured to transmit the first data frame including the media data through the first channel and the second channel among the plurality of channels during the data transfer period, and control the preamble of the third channel adjacent to the first channel to be different from or orthogonal to the preamble of the first channel, and control the preamble of the fourth channel adjacent to the second channel to be different from or orthogonal to the preamble of the second channel.

Meanwhile, the transceiver can be configured to transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel and the second channel among the plurality of channels during the data transfer period, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel.

Meanwhile, the transceiver can be configured to transmit the data frame including the legacy-short training field (L-STF), the legacy-channel estimation field (L-CEF), the legacy (L)-header, the EDMG (E)-header, and the media data when the EDMG PPDU-based data frame is transmitted through the first channel among the plurality of channels during the data transfer period, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel.

Meanwhile, the transceiver can be configured to transmit a first signal based on a beam having a first shape in which a sector is sequentially varied during a first period, receive a second signal based on the beam having the first shape from the display device during a third period based on selection of the wireless media device of the display device during a second period, approve association with the display device based on network address information in the second signal during a fourth period, transmit a third signal based on a beam having a second shape at an angle smaller than that of the first shape during a fifth period, and transmit the media data to the display device based on the beam having the second shape during a sixth period, and control the preamble of the channel adjacent to the transmission channel, and the preamble of the transmission channel to be different from or orthogonal to each other during at least one period among the first period to the sixth period.

A wireless media device according to another embodiment of the present disclosure includes: a signal processing device configured to process an image signal or an audio signal; and a transceiver configured to wirelessly transmit a signal from the signal processing device to an external display device, and the transceiver is configured to transmit, to the display device, a data frame including a preamble and media data through at least one transmission channel among a plurality of channels, and control a sequence of the data frame of the transmission channel, and a sequence of a data frame of a channel adjacent to the transmission channel to be different from or orthogonal to each other.

Meanwhile, the transceiver can be configured to transmit a first signal based on a beam having a first shape in which a sector is sequentially varied during a first period, receive a second signal based on the beam having the first shape from the display device during a third period based on selection of the wireless media device of the display device during a second period, approve association with the display device based on network address information in the second signal during a fourth period, transmit a third signal based on a beam having a second shape at an angle smaller than that of the first shape during a fifth period, and transmit the media data to the display device based on the beam having the second shape during a sixth period, and control the sequence of the data frame of the transmission channel, and the sequence of the data frame of the channel adjacent to the transmission channel to be different from or orthogonal to each other during at least one period among the first period to the sixth period.

Meanwhile, an image display apparatus according to an embodiment of the present disclosure includes: a display device; and a wireless media device, and the wireless media device is configured to include: a signal processing device configured to process an image signal or an audio signal; and a transceiver configured to wirelessly transmit a signal from the signal processing device to an external display device, and the transceiver is configured to transmit, to the display device, a data frame including a preamble, a header, and media data through at least one transmission channel among a plurality of channels, and control a preamble of a channel adjacent to the transmission channel, and a preamble of the transmissions channel to be different from or orthogonal to each other.

Meanwhile, an image display apparatus according to another embodiment of the present disclosure includes: a display device; and a wireless media device, and the wireless media device is configured to include: a signal processing device configured to process an image signal or an audio signal; and a transceiver configured to wirelessly transmit a signal from the signal processing device to an external display device, and the transceiver is configured to transmit, to the display device, a data frame including a preamble and media data through at least one transmission channel among a plurality of channels, and control a sequence of the data frame of the transmission channel, and a sequence of a data frame of a channel adjacent to the transmission channel to be different from or orthogonal to each other.

### EFFECTS OF THE DISCLOSURE

A wireless media device according to an embodiment of the present disclosure includes: a signal processing device configured to process an image signal or an audio signal; and a transceiver configured to wirelessly transmit a signal from the signal processing device to an external display device, and the transceiver is configured to transmit, to the display device, a data frame including a preamble, a header, and media data through at least one transmission channel among a plurality of channels, and control a preamble of a channel adjacent to the transmission channel, and a preamble of the transmissions channel to be different from or orthogonal to each other. Accordingly, it is possible to reduce channel interference of adjacent channels during the wireless media transmission. Furthermore, it is possible to stably transmit the media data during the wireless media transmission.

Meanwhile, the transceiver can be configured to control the preamble of the channel adjacent to the transmission channel, and the preamble of the transmission channel to be different from or orthogonal to each other during a data transfer period of transmitting the media data to the display device. Accordingly, it is possible to reduce channel interference of adjacent channels during the wireless media transmission.

Meanwhile, the transceiver can be configured to transmit a data frame including a legacy-short training field (L-STF), a legacy-channel estimation field (L-CEF), a legacy (L)-header, and the media data when a non-enhanced directional multi-gigabit PHY protocol data unit (EDMG PPDU)-based data frame is transmitted through the transmission channel among the plurality of channels during the data transfer period, and control an L-STF in the preamble of the transmission channel to be different from or orthogonal to an L-STF in the preamble of the channel adjacent to the transmission channel. Accordingly, it is possible to reduce channel interference of adjacent channels during the wireless media transmission.

Meanwhile, the transceiver can be configured to transmit a data frame including the legacy-short training field (L-STF), the legacy-channel estimation field (L-CEF), the legacy (L)-header, an EDMG (E)-header, and the media data when an EDMG PPDU-based data frame is transmitted through the transmission channel among the plurality of channels during the data transfer period, and control the L-STF in the preamble of the transmission channel to be different from or orthogonal to the L-STF in the preamble of the channel adjacent to the transmission channel. Accordingly, it is possible to reduce channel interference of adjacent channels during the wireless media transmission.

Meanwhile, the EDMG PPDU-based data frame can further include an EDMG-short training field (E-STF) and an EDMG-channel estimation field (E-CEF). Accordingly, it is possible to reduce channel interference of adjacent channels during the wireless media transmission.

Meanwhile, the transceiver can be configured to transmit a first data frame including the media data through a first channel among the plurality of channels during the data transfer period, and control a preamble of each of a second channel and a third channel adjacent to the first channel, and the preamble of the first channel to be different from or orthogonal to each other. Accordingly, it is possible to reduce channel interference of adjacent channels during the wireless media transmission.

Meanwhile, the transceiver can be configured to transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel among the plurality of channels during the data transfer period, and control an L-STF in the preamble of the first channel to be different from or orthogonal to L-STFs in the preambles of the second channel and the third channel adjacent to the first channel. Accordingly, it is possible to reduce channel interference of adjacent channels during the wireless media transmission.

Meanwhile, the transceiver can be configured to transmit the data frame including the legacy-short training field (L-STF), the legacy-channel estimation field (L-CEF), the legacy (L)-header, an EDMG (E)-header, and the media data when the EDMG PPDU-based data frame is transmitted through the first channel among the plurality of channels during the data transfer period, and control the L-STF in the preamble of the first channel to be different from or orthogonal to the L-STF in the preamble of the channel adjacent to the first channel. Accordingly, it is possible to reduce channel interference of adjacent channels during the wireless media transmission.

Meanwhile, the transceiver can be configured to transmit a first data and a second data frame including the media data through the first channel and the second channel among the plurality of channels during the data transfer period, and control a preamble of a third channel adjacent to the first channel to be different from or orthogonal to the preamble of the first channel, and control a preamble of a fourth channel adjacent to the second channel to be different from or orthogonal to the preamble of the second channel. Accordingly, it is possible to reduce channel interference of adjacent channels during the wireless media transmission.

Meanwhile, the transceiver can be configured to transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel and the second channel among the plurality of channels during the data transfer period, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel. Accordingly, it is possible to reduce channel interference of adjacent channels during the wireless media transmission.

Meanwhile, the transceiver can be configured to transmit the data frame including the legacy-short training field (L-STF), the legacy-channel estimation field (L-CEF), the legacy (L)-header, the EDMG (E)-header, and the media data when the EDMG PPDU-based data frame is transmitted through the first channel among the plurality of channels during the data transfer period, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel. Accordingly, it is possible to reduce channel interference of adjacent channels during the wireless media transmission.

Meanwhile, the transceiver can be configured to transmit the first data frame including the media data through the first channel and the second channel among the plurality of channels during the data transfer period, and control the preamble of the third channel adjacent to the first channel to be different from or orthogonal to the preamble of the first channel, and control the preamble of the fourth channel adjacent to the second channel to be different from or orthogonal to the preamble of the second channel. Accordingly, it is possible to reduce channel interference of adjacent channels during the wireless media transmission.

Meanwhile, the transceiver can be configured to transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel and the second channel among the plurality of channels during the data transfer period, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel. Accordingly, it is possible to reduce channel interference of adjacent channels during the wireless media transmission.

Meanwhile, the transceiver can be configured to transmit the data frame including the legacy-short training field (L-STF), the legacy-channel estimation field (L-CEF), the legacy (L)-header, the EDMG (E)-header, and the media data when the EDMG PPDU-based data frame is transmitted through the first channel among the plurality of channels during the data transfer period, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel. Accordingly, it is possible to reduce channel interference of adjacent channels during the wireless media transmission.

Meanwhile, the transceiver can be configured to transmit a first signal based on a beam having a first shape in which a sector is sequentially varied during a first period, receive a second signal based on the beam having the first shape from the display device during a third period based on selection of the wireless media device of the display device during a second period, approve association with the display device based on network address information in the second signal during a fourth period, transmit a third signal based on a beam having a second shape at an angle smaller than that of the first shape during a fifth period, and transmit the media data to the display device based on the beam having the second shape during a sixth period, and control the preamble of the channel adjacent to the transmission channel, and the preamble of the transmission channel to be different from or orthogonal to each other during at least one period among the first period to the sixth period. Accordingly, it is possible to reduce channel interference of adjacent channels during the wireless media transmission.

A wireless media device according to another embodiment of the present disclosure includes: a signal processing device configured to process an image signal or an audio signal; and a transceiver configured to wirelessly transmit a signal from the signal processing device to an external display device, and the transceiver is configured to transmit, to the display device, a data frame including a preamble and media data through at least one transmission channel among a plurality of channels, and control a sequence of the data frame of the transmission channel, and a sequence of a data frame of a channel adjacent to the transmission channel to be different from or orthogonal to each other. Accordingly, it is possible to reduce channel interference of adjacent channels during the wireless media transmission. Furthermore, it is possible to stably transmit the media data during the wireless media transmission.

Meanwhile, the transceiver can be configured to transmit a first signal based on a beam having a first shape in which a sector is sequentially varied during a first period, receive a second signal based on the beam having the first shape from the display device during a third period based on selection of the wireless media device of the display device during a second period, approve association with the display device based on network address information in the second signal during a fourth period, transmit a third signal based on a beam having a second shape at an angle smaller than that of the first shape during a fifth period, and transmit the media data to the display device based on the beam having the second shape during a sixth period, and control the sequence of the data frame of the transmission channel, and the sequence of the data frame of the channel adjacent to the transmission channel to be different from or orthogonal to each other during at least one period among the first period to the sixth period. Accordingly, it is possible to reduce channel interference of adjacent channels during the wireless media transmission.

Meanwhile, an image display apparatus according to an embodiment of the present disclosure includes: a display device; and a wireless media device, and the wireless media device is configured to include: a signal processing device configured to process an image signal or an audio signal; and a transceiver configured to wirelessly transmit a signal from the signal processing device to an external display device, and the transceiver is configured to transmit, to the display device, a data frame including a preamble, a header, and media data through at least one transmission channel among a plurality of channels, and control a preamble of a channel adjacent to the transmission channel, and a preamble of the transmissions channel to be different from or orthogonal to each other. Accordingly, it is possible to reduce channel interference of adjacent channels during the wireless media transmission. Furthermore, it is possible to stably transmit the media data during the wireless media transmission.

Meanwhile, an image display apparatus according to another embodiment of the present disclosure includes: a display device; and a wireless media device, and the wireless media device is configured to include: a signal processing device configured to process an image signal or an audio signal; and a transceiver configured to wirelessly transmit a signal from the signal processing device to an external display device, and the transceiver is configured to transmit, to the display device, a data frame including a preamble and media data through at least one transmission channel among a plurality of channels, and control a sequence of the data frame of the transmission channel, and a sequence of a data frame of a channel adjacent to the transmission channel to be different from or orthogonal to each other. Accordingly, it is possible to reduce channel interference of adjacent channels during the wireless media transmission. Furthermore, it is possible to stably transmit the media data during the wireless media transmission.

### BRIEF DESCRIPTION OF THE DRAWINGS

FIG. 1 is a diagram showing an image display apparatus according to an embodiment of the present disclosure;

FIG. 2 is an internal block diagram of an image display apparatus according to an embodiment of the present disclosure;

FIG. 3 is an internal block diagram of a signal processing device of FIG. 2;

FIG. 4A is a diagram showing a method of controlling a remote controller of FIG. 2;

FIG. 4B is an internal block diagram of the remote controller of FIG. 2;

FIG. 5 is an internal block diagram of a display of FIG. 2;

FIGS. 6A and 6B are diagrams referred to in the description of an organic light emitting diode panel of FIG. 5;

FIG. 7 is a diagram referred to in the description of a transceiver of FIG. 2 and a second transceiver;

FIG. 8 is a flowchart illustrating an operation of an image display apparatus;

FIG. 9 is a diagram referred to in the description of FIG. 8;

FIGS. 10A to 11B are diagrams referred to in the description of an operation of a wireless media device related to the present disclosure;

FIGS. 12A and 12B are diagrams referred to in the description of an operation of a wireless media device according to an embodiment of the present disclosure;

FIG. 13 is a flowchart illustrating an example of an operation of the wireless media device according to an embodiment of the present disclosure;

FIG. 14 is a flowchart illustrating another example of the operation of the wireless media device according to an embodiment of the present disclosure; and

FIGS. 15A to 18B are diagrams referred to in the description of FIG. 13 or 14.

### DETAILED DESCRIPTION OF THE PREFERRED EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” can be used interchangeably.

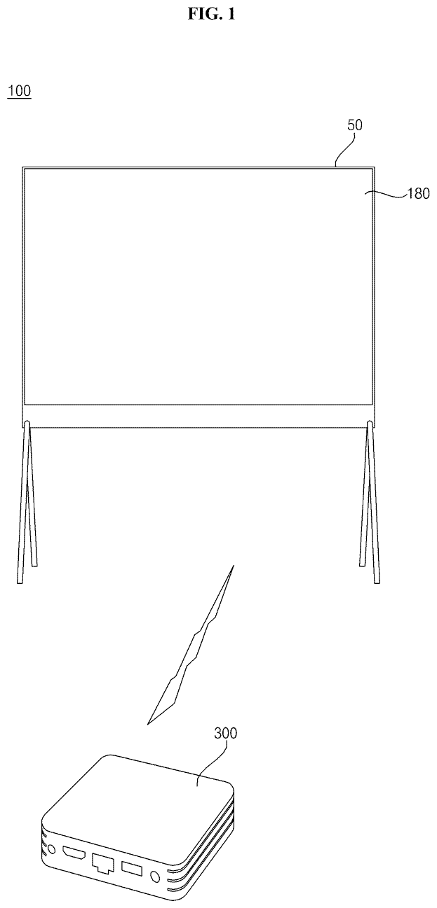

FIG. 1 is a diagram showing an image display apparatus according to an embodiment of the present disclosure.

Referring to FIG. 1, an image display apparatus 100 according to an embodiment of the present disclosure includes a display device 50 and a wireless media device 300.

The wireless media device 300 and the display device 50 in the image display apparatus 100 according to an embodiment of the present disclosure are separated from each other and wirelessly transmit and receive media.

Meanwhile, the wireless media device 300 in the image display apparatus 100 can wirelessly transmit an image signal or an audio signal to the display device 50 using a non-compression method.

For example, the wireless media device 300 in the image display apparatus 100 can be configured to transmit an image signal or an audio signal to the display device 50 based on wireless communication based on the 802.11 ad/ay standard.

When the wireless media device 300 transmits an uncompressed image signal or audio signal to the display device 50, the wireless media device 300 can be configured to transmit media data to the display device 50 using a frequency based on 60 GHz in order to secure a stable wireless bandwidth.

Meanwhile, when media is transmitted from the wireless media device 300 to the display device 50 by a wireless communication scheme, channel interference can occur in an adjacent channel due to an adjacent wireless transceiver (e.g., a mobile terminal, an AP device, or the like).

When the channel interference occurs, a possibility of an error during media transmission increases, and when an error occurs, there is a problem in that a broken screen is displayed or pop noise or the like is output.

To this end, the wireless media device 300 according to an embodiment of the present disclosure transmits, to the display device 50, a data frame including a preamble, a header, and media data through at least one transmission channel among a plurality of channels, and controls a preamble of a channel adjacent to the transmission channel to be different from or orthogonal to the preamble of the transmission channel. Accordingly, it is possible to reduce channel interference of adjacent channels during wireless media transmission. Furthermore, it is possible to stably transmit media data during the wireless media transmission.

Meanwhile, the wireless media device 300 according to another embodiment of the present disclosure transmits, to the display device 50, a data frame including a preamble and media data through at least one transmission channel among a plurality of channels, and controls a sequence of data frames of the transmission channel to be different from or orthogonal to a sequence of data frames of a channel adjacent to the transmission channel. Accordingly, it is possible to reduce channel interference of adjacent channels during the wireless media transmission. Furthermore, it is possible to stably transmit media data during the wireless media transmission.

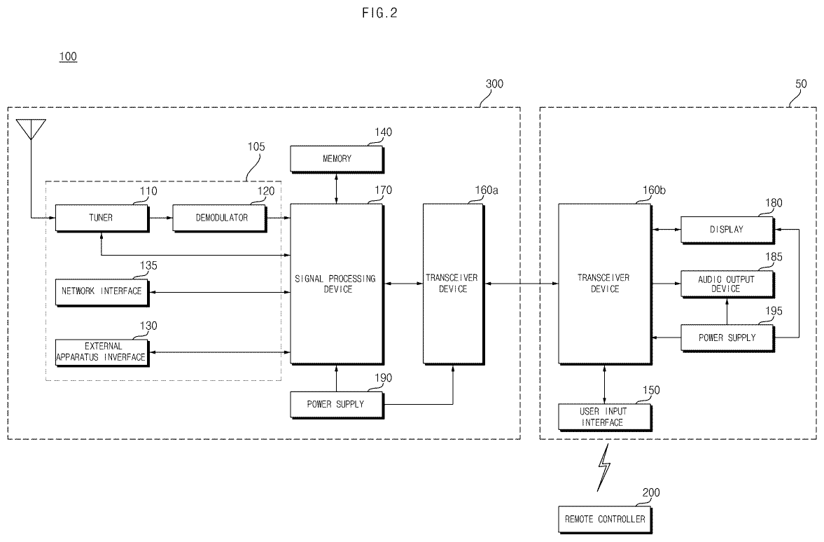

FIG. 2 is an internal block diagram of an image display apparatus according to an embodiment of the present disclosure.

Referring to FIG. 2, the image display apparatus 100 according to an embodiment of the present disclosure includes the wireless media device 300 and the display device 50.

The wireless media device 300 can include an image receiver 105, a memory 140, a power supply 190, a signal processing device 170, and a transceiver 160a.

The display device 50 can include a second transceiver 160b, a user input interface 150, a display 180, an audio output device 185, and a power supply 195.

The image receiver 105 can include a tuner 110, a demodulator 120, a network interface 135, and an external apparatus device 130.

The tuner 110 selects an RF broadcast signal corresponding to a channel selected by a user or all pre-stored channels among radio frequency (RF) broadcast signals received through an antenna 50. In addition, the selected RF broadcast signal is converted into an intermediate frequency signal, a baseband image, or an audio signal.

For example, if the selected RF broadcast signal is a digital broadcast signal, the digital broadcast signal is converted into a digital IF signal (DIF), and if the selected RF broadcast signal is an analog broadcast signal, the analog broadcast signal is converted into an analog baseband image or audio signal (CVBS/SIF). That is, the tuner 110 can process the digital broadcast signal or an analog broadcast signal. The analog baseband image or audio signal (CVBS/SIF) output from the tuner 110 can be directly input to the signal processing device 170.

Meanwhile, the tuner 110 can include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 can be configured to perform demodulation and channel decoding and then output a stream signal TS. At this time, the stream signal can be a multiplexed signal of an image signal, an audio signal, or a data signal.

The stream signal output from the demodulator 120 can be input to the signal processing device 170. The signal processing device 170 performs demultiplexing, image/audio signal processing, and the like, and then outputs an image to the display 180 and outputs audio to the audio output device 185.

The external apparatus interface 130 can be configured to transmit or receive data to and from a connected external apparatus (not shown). To this end, the external apparatus interface 130 can include an A/V input/output device (not shown) or a wireless communication unit (not shown).

The external apparatus interface 130 can be connected in wired or wirelessly to an external apparatus, such as a digital versatile disk (DVD), a Blu ray, a game equipment, a camera, a camcorder, a computer (note book), a set-top box, and USB device, and can be configured to perform an input/output operation with an external apparatus.

The A/V input and output device can be configured to receive image and audio signals from an external apparatus. Meanwhile, a wireless transceiver can be configured to perform short-range wireless communication with other electronic apparatus.

The network interface 135 provides an interface for connecting the image display apparatus 100 to a wired/wireless network including the Internet network. For example, the network interface 135 can be configured to receive, via the network, content or data provided by the Internet, a content provider, or a network operator.

The memory 140 can store a program for each signal processing and control in the signal processing device 170, and can store signal-processed image, audio, or data signal.

In addition, the memory 140 can serve to temporarily store image, audio, or data signal input to the external apparatus interface 130. In addition, the memory 140 can store information on a certain broadcast channel through a channel memory function, such as a channel map.

Although FIG. 2 illustrates that the memory is provided separately from the signal processing device 170, the scope of the present disclosure is not limited thereto. The memory 140 can be included in the signal processing device 170.

The signal processing device 170 can demultiplex an input stream through the tuner 110, the demodulator 120, or the external apparatus interface 130, or process demultiplexed signals to generate and output a signal for image or audio output.

The image signal processed by the signal processing device 170 is input to the display 180, and can be displayed as an image corresponding to the image signal. In addition, the image signal processed by the signal processing device 170 can be input to the external output apparatus through the external apparatus interface 130.

The audio signal processed by the signal processing device 170 can be output to the audio output device 185 as an audio signal. In addition, audio signal processed by the signal processing device 170 can be input to the external output apparatus through the external apparatus interface 130.

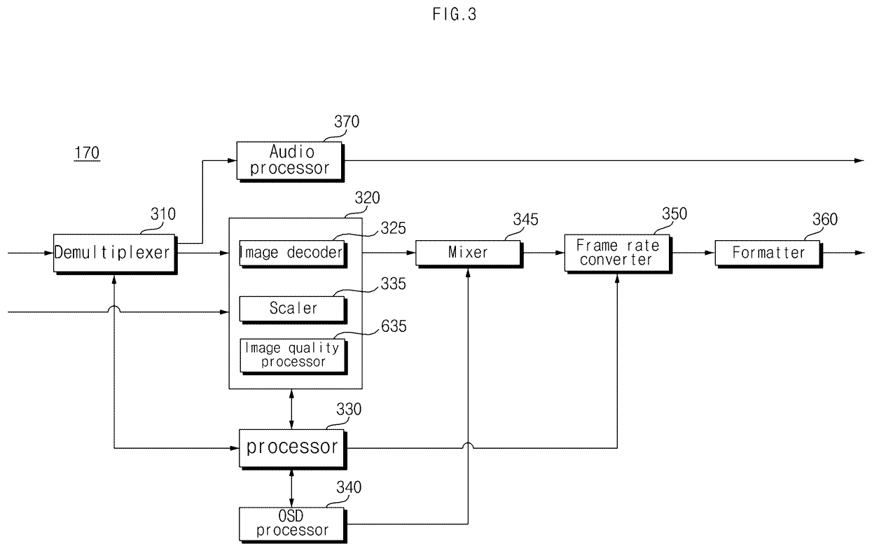

Although not shown in FIG. 2, the signal processing device 170 can include a demultiplexer, an image processor, and the like. This will be described later with reference to FIG. 3.

In addition, the signal processing device 170 can control the overall operation of the image display apparatus 100. For example, the signal processing device 170 can control the tuner 110 to control the tuning of the RF broadcast corresponding to the channel selected by the user or the previously stored channel.

In addition, the signal processing device 170 can control the image display apparatus 100 according to a user command input through the user input interface 150 or an internal program.

Meanwhile, the signal processing device 170 can control the display 180 to display an image. At this time, the image displayed on the display 180 can be a still image or a moving image.

Meanwhile, the signal processing device 170 can recognize the position of the user based on the image photographed by a photographing device (not shown). For example, the distance (z-axis coordinate) between a user and the image display apparatus 100 can be determined. In addition, the x-axis coordinate and the y-axis coordinate in the display 180 corresponding to a user position can be determined.

Meanwhile, although not shown in the figure, a channel browsing processor generating a thumbnail image corresponding to a channel signal or an external input signal can be further provided. The channel browsing processor can be configured to receive a stream signal (TS) output from the demodulator 120 or a stream signal output from the external apparatus device 130, extract an image from the input stream signal, and generate a thumbnail image.

The generated thumbnail image can be stream-decoded together with the decoded image and input to the signal processing device 170. The signal processing device 170 can display a thumbnail list including a plurality of thumbnail images on the display 180 using the input thumbnail image.

At this time, the thumbnail list can be displayed in a simple view manner in which the thumbnail list is displayed in a partial region in a state in which a certain image is displayed on the display 180, or can be displayed in a full view manner in which the thumbnail list is displayed in most regions of the display 180. Thumbnail images in the thumbnail list can be sequentially updated.

The power supply 190 supplies corresponding power throughout the wireless media device 300. In particular, the power supply 190 can supply power to the signal processing device 170, which can be implemented in the form of a system on chip (SOC), the transceiver 160a for communication, the image receiver 105, and the memory 140.

Meanwhile, the power supply 190 can include a converter that converts AC power into DC power and a dc/dc converter that converts a level of DC power.

The transceiver 160a can be configured to perform wireless communication with the second transceiver 160b in the display device 50.

The second transceiver 160b can be configured to perform wireless communication with the transceiver 160a within the wireless media device 300.

An image signal and an audio signal received by the second transceiver 160b can be transmitted to the display 180 and the audio output device 185, respectively.

The display 180 generates a driving signal by converting an image signal, a data signal, an OSD signal, a control signal processed by the signal processing device 170, an image signal, a data signal, a control signal, and the like received from the external apparatus interface 130.

The display 180 can be an LCD, OLED, inorganic LED, flexible display, or the like, and can also be a 3D display.

Meanwhile, the display 180 can be configured as a touch screen and used as an input device in addition to an output device.

The audio output device 185 converts the audio signal received from the second transceiver 160b into sound and outputs the sound.

Meanwhile, the audio output device 185 can include at least one speaker.

Meanwhile, the power supply 195 supplies corresponding power throughout the display device 50. In particular, the power supply 195 can supply power to each of the second transceiver 160b for communication, the display 180, the audio output device 185, and the user input interface 150.

Meanwhile, the power supply 195 can include a converter that converts AC power into DC power, and a dc/dc converter that converts a level of DC power.

The user input interface 150 can be configured to transmit a signal input by the user to the second transceiver 160b. Then, the second transceiver 160b can wirelessly transmit the signal input by the user to the transceiver 160a, and the signal processing device 170 can be configured to receive the signal input by the user through the transceiver 160a.

For example, a user input signal, such as power ON/OFF, channel selection, and screen setting, from the remote controller 200 or a user input signal input from a local key (not shown), such as power key, channel key, volume key, and set value, can be transmitted to the signal processing device 170 via the second transceiver 160b and the transceiver 160a.

Meanwhile, the signal processing device 170 can be configured to transmit various types of information or signals to the remote controller 200 via the transceiver 160a, the second transceiver 160b, and the user input interface 150.

The remote controller 200 transmits the user input to the user input interface 150. To this end, the remote controller 200 can use Bluetooth, a radio frequency (RF) communication, an infrared (IR) communication, an Ultra Wideband (UWB), ZigBee, or the like. In addition, the remote controller 200 can be configured to receive the image, audio, or data signal output from the user input interface 150, and display it on the remote controller 200 or output it as an audio.

Meanwhile, the image display apparatus 100 can be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram can be integrated, added, or omitted according to a specification of the image display apparatus 100 actually implemented. That is, two or more components can be combined into a single component as needed, or a single component can be split into two or more components. The function performed in each block is described for the purpose of illustrating embodiments of the present disclosure, and specific operation and apparatus do not limit the scope of the present disclosure.

FIG. 3 is an internal block diagram of the signal processing device in FIG. 2.

Referring to the figure, the signal processing device 170 according to an embodiment of the present disclosure can include a demultiplexer 310, an image processor 320, a processor 330, an OSD processor 340, a mixer 345, a frame rate converter 350, a formatter 360, and an audio processor 370. In addition, the signal processing device 170 can further include an audio processor 370 and a data processor (not shown).

The demultiplexer 310 demultiplexes the input stream. For example, in case in which an MPEG-2 TS is input, it can be demultiplexed into image, audio, and data signal, respectively. Here, the stream signal input to the demultiplexer 310 can be a stream signal output from the tuner 110, the demodulator 120, or the external apparatus interface 130.

The image processor 320 can be configured to perform image processing on a demultiplexed image signal. To this end, the image processor 320 can include an image decoder 325 and a scaler 335.

The image decoder 325 decodes a demultiplexed image signal, and the scaler 335 performs scaling so that the resolution of the decoded image signal can be output from the display 180.

The image decoder 325 can include a decoder of various standards.

The processor 330 can control overall operations within the signal processing device 170. For example, the processor 330 can control the tuner 110 to select (tune) an RF broadcast corresponding to a channel selected by the user or a pre-stored channel.

Also, the processor 330 can control the image display apparatus 100 according to a user command input through the user input interface 150 or an internal program.

Also, the processor 330 can control data transmission with the network interface 135 or the external apparatus device 130.

Also, the processor 330 can control operations of the demultiplexer 310, the image processor 320, the OSD processor 340, and the like within the signal processing device 170.

The OSD processor 340 generates an OSD signal according to a user input or by itself. For example, based on a user input signal, the OSD processor 340 can generate a signal for displaying various information as a graphic or a text on the screen of the display 180. The generated OSD signal can include various data, such as a user interface screen of the image display apparatus 100, various menu screens, a widget, and an icon. In addition, the generated OSD signal can include a 2D object or a 3D object.

In addition, the OSD processor 340 can generate a pointer that can be displayed on the display, based on a pointing signal input from the remote controller 200. In particular, such a pointer can be generated by a pointing signal processor, and the OSD processor 340 can include such a pointing signal processor (not shown). Obviously, the pointing signal processor (not shown) can be provided separately from the OSD processor 340.

The mixer 345 can mix the OSD signal generated by the OSD processing unit 340 and the decoded image signal image-processed by the image processor 320. In this case, the OSD signal and the decoded image signal can each include at least one of a 2D signal and a 3D signal. The mixed image signal is provided to the frame rate converter 350.

The frame rate converter (FRC) 350 can convert a frame rate of an input image. Meanwhile, the frame rate converter 350 can output the input image without converting the frame rate.

Meanwhile, the formatter 360 can be configured to receive a signal mixed by the mixer 345, that is, an OSD signal, and the decoded image signal, and change a format of the image signal.

Meanwhile, although not shown in the figure, it is possible to further dispose a 3D processor (not shown) for 3D effect signal processing after the formatter 360. Such a 3D processor (not shown) can process brightness, tint, and color control of an image signal to improve a 3D effect. For example, signal processing can be performed to make a short distance clear and a long distance blur. Meanwhile, the function of the 3D processor can be merged into the formatter 360 or merged into the image processor 320.

Meanwhile, the audio processor 370 in the signal processing device 170 can process a demultiplexed audio signal or an audio signal of certain content. To this end, the audio processor 370 can include various decoders.

In addition, the audio processor 370 in the signal processing device 170 can process a base, a treble, a volume control, and the like.

The data processor (not shown) in the signal processing device 170 can be configured to perform data processing of the demultiplexed data signal. For example, in case in which the demultiplexed data signal is a coded data signal, it can be decoded. The encoded data signal can be electronic program guide information including broadcast information, such as a start time and an end time of a broadcast program broadcasted on each channel.

Meanwhile, in FIG. 3, it is illustrated that signals from the OSD processor 340 and the image processor 320 are mixed in the mixer 345 and then processed in the formatter 360, but the present disclosure is not limited thereto, and the mixer can be located behind the formatter.

Meanwhile, a block diagram of the signal processing device 170 shown in FIG. 3 is a block diagram for an embodiment of the present disclosure. Each component of the block diagram can be integrated, added, or omitted according to a specification of the signal processing device 170 actually implemented.

In particular, the frame rate converter 350 and the formatter 360 can not be provided in the signal processing device 170, but can be separately provided or separately provided as a single module.

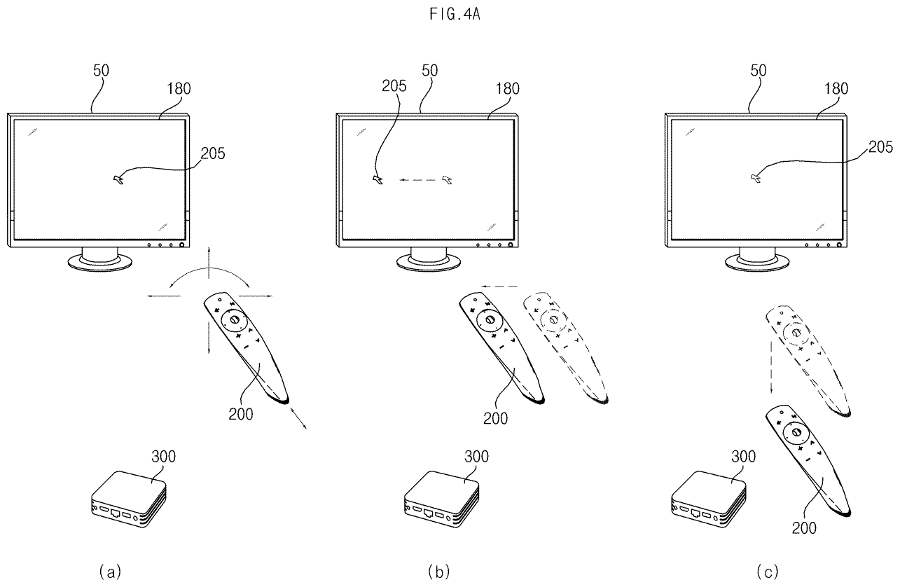

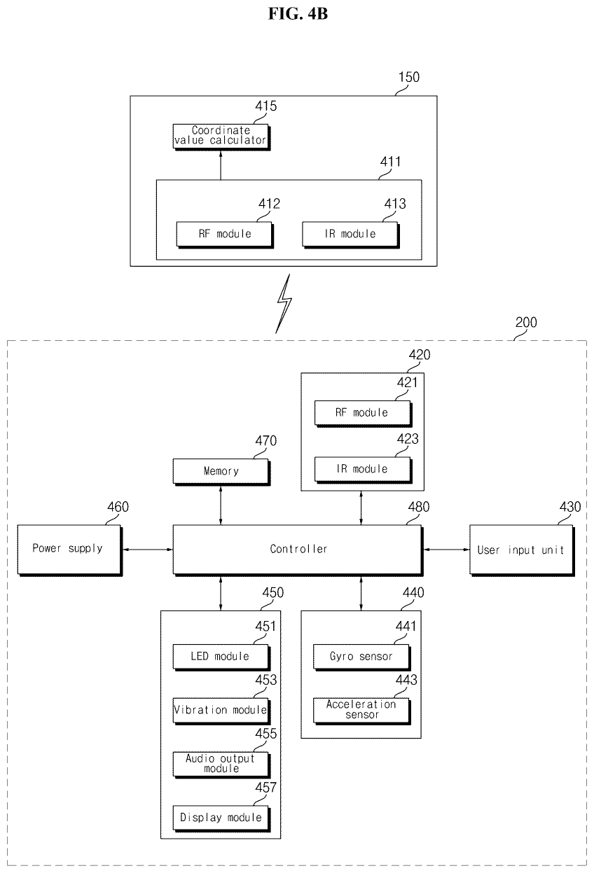

FIG. 4A is a diagram illustrating a control method of a remote controller of FIG. 2.

As shown in FIG. 4A(a), it is illustrated that a pointer 205 corresponding to the remote controller 200 is displayed on the display 180.

The user can move or rotate the remote controller 200 up and down, left and right (FIG. 4A(b)), and back and forth (FIG. 4A(c)). The pointer 205 displayed on the display 180 of the image display apparatus corresponds to the motion of the remote controller 200. Such a remote controller 200 can be referred to as a space remote controller or a 3D pointing apparatus, because the pointer 205 is moved and displayed according to the movement in a 3D space, as shown in the figure.

FIG. 4A(b) illustrates that in case in which the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus can calculate the coordinate of the pointer 205 from the information on the motion of the remote controller 200. The image display apparatus can display the pointer 205 to correspond to the calculated coordinate.

FIG. 4A(c) illustrates a case in which the user moves the remote controller 200 away from the display 180, while pressing a specific button of the remote controller 200. Thus, a selection region within the display 180 corresponding to the pointer 205 can be zoomed in so that it can be displayed to be enlarged. Meanwhile, in case in which the user moves the remote controller 200 close to the display 180, the selection region within the display 180 corresponding to the pointer 205 can be zoomed out so that it can be displayed to be reduced. Meanwhile, in case in which the remote controller 200 moves away from the display 180, the selection region can be zoomed out, and in case in which the remote controller 200 approaches the display 180, the selection region can be zoomed in.

Meanwhile, in case in which the specific button of the remote controller 200 is pressed, it is possible to exclude the recognition of vertical and lateral movement. That is, in case in which the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state in which the specific button of the remote controller 200 is not pressed.

Meanwhile, the moving speed or the moving direction of the pointer 205 can correspond to the moving speed or the moving direction of the remote controller 200.

FIG. 4B is an internal block diagram of the remote controller of FIG. 2.

Referring to the figure, the remote controller 200 includes a wireless transceiver 425, a user input device 435, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 can include an RF module 421 for transmitting and receiving signals to and from the image display apparatus 100 according to a RF communication standard. In addition, the remote controller 200 can include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 can be configured to receive the signal transmitted by the image display apparatus 100 through the RF module 421. In addition, if necessary, the remote controller 200 can be configured to transmit a command related to power on/off, channel change, volume change, and the like to the image display apparatus 100 through the IR module 423.

The user input device 435 can be implemented by a keypad, a button, a touch pad, a touch screen, or the like. The user can operate the user input device 435 to input a command related to the image display apparatus 100 to the remote controller 200. in case in which the user input device 435 includes a hard key button, the user can input a command related to the image display apparatus 100 to the remote controller 200 through a push operation of the hard key button. in case in which the user input device 435 includes a touch screen, the user can touch a soft key of the touch screen to input the command related to the image display apparatus 100 to the remote controller 200. In addition, the user input device 435 can include various types of input means, such as a scroll key, a jog key, etc., which can be operated by the user, and the present disclosure does not limit the scope of the present disclosure.

The sensor device 440 can include a gyro sensor 441 or an acceleration sensor 443. The gyro sensor 441 can sense information regarding the motion of the remote controller 200.

For example, the gyro sensor 441 can sense information on the operation of the remote controller 200 based on the x, y, and z axes. The acceleration sensor 443 can sense information on the moving speed of the remote controller 200. Meanwhile, a distance measuring sensor can be further provided, and thus, the distance to the display 180 can be sensed.

The output device 450 can output an image or an audio signal corresponding to the operation of the user input device 435 or a signal transmitted from the image display apparatus 100. Through the output device 450, the user can recognize whether the user input device 435 is operated or whether the image display apparatus 100 is controlled.

For example, the output device 450 can include an LED module 451 that is turned on in case in which the user input device 435 is operated or a signal is transmitted/received to/from the image display apparatus 100 through the wireless transceiver 425, a vibration module 453 for generating a vibration, an audio output module 455 for outputting an audio, or a display 457 for outputting an image.

The power supply 460 supplies power to the remote controller 200. in case in which the remote controller 200 is not moved for a certain time, the power supply 460 can stop the supply of power to reduce a power waste. The power supply 460 can resume power supply in case in which a certain key provided in the remote controller 200 is operated.

The memory 470 can store various types of programs, application data, and the like necessary for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. The controller 480 of the remote controller 200 can store information regarding a frequency band or the like for wirelessly transmitting and receiving a signal to/from the image display apparatus 100 paired with the remote controller 200 in the memory 470 and can refer to the stored information.

The controller 480 controls various matters related to the control of the remote controller 200. The controller 480 can be configured to transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that can wirelessly transmit and receive a signal to and from the remote controller 200 and a coordinate value calculator 415 that can calculate the coordinate value of a pointer corresponding to the operation of the remote controller 200.

The user input interface 150 can wirelessly transmit and receive a signal to and from the remote controller 200 through the RF module 412. In addition, the user input interface 150 can be configured to receive a signal transmitted by the remote controller 200 through the IR module 413 according to a IR communication standard.

The coordinate value calculator 415 can correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 can be configured to determine the information on the operation of the remote controller 200 and the key operation from the signal transmitted from the remote controller 200, and, correspondingly, control the image display apparatus 100.

For another example, the remote controller 200 can calculate the pointer coordinate value corresponding to the operation and output it to the user input interface 150 of the image display apparatus 100. In this case, the user input interface 150 of the image display apparatus 100 can be configured to transmit information on the received pointer coordinate value to the controller 180 without a separate correction process of hand shake or error.

For another example, unlike the figure, the coordinate value calculator 415 can be provided in the signal processing device 170, not in the user input interface 150.

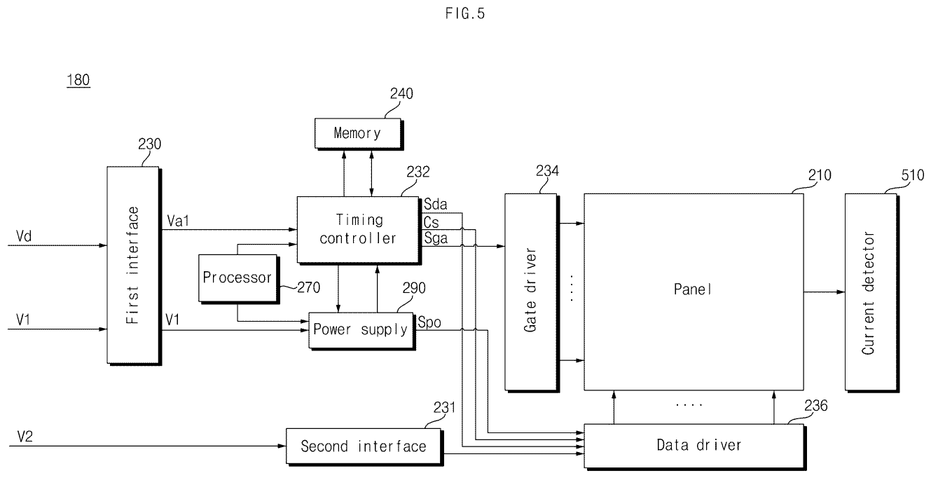

FIG. 5 is an internal block diagram of a display of FIG. 2.

Referring to FIG. 5, the display 180 can include an organic light emitting diode panel 210, a first interface 230, a second interface 231, a timing controller 232, a gate driver 234, a data driver 236, a memory 240, a processor 270, a power supply 290, a current detector 510, and the like.

The display 180 receives an image signal Vd, a first DC power V1, and a second DC power V2, and can display a certain image based on the image signal Vd.

Meanwhile, the first interface 230 in the display 180 can be configured to receive the image signal Vd and the first DC power V1 from the signal processing device 170.

Here, the first DC power V1 can be used for the operation of the power supply 290 and the timing controller 232 in the display 180.

Next, the second interface 231 can be configured to receive a second DC power V2 from an external power supply 190. Meanwhile, the second DC power V2 can be input to the data driver 236 in the display 180.

The timing controller 232 can output a data driving signal Sda and a gate driving signal Sga, based on the image signal Vd.

For example, in case in which the first interface 230 converts the input image signal Vd and outputs the converted image signal va1, the timing controller 232 can output the data driving signal Sda and the gate driving signal Sga based on the converted image signal va1.

The timing controller 232 can further receive a control signal, a vertical synchronization signal Vsync, and the like, in addition to the image signal Vd from the signal processing device 170.

In addition to the image signal Vd, based on a control signal, a vertical synchronization signal Vsync, and the like, the timing controller 232 generates a gate driving signal Sga for the operation of the gate driver 234, and a data driving signal Sda for the operation of the data driver 236.

At this time, in case in which the panel 210 includes a RGBW subpixel, the data driving signal Sda can be a data driving signal for driving of RGBW subpixel.

Meanwhile, the timing controller 232 can further output a control signal Cs to the gate driver 234.

The gate driver 234 and the data driver 236 supply a scan signal and an image signal to the organic light emitting diode panel 210 through a gate line GL and a data line DL respectively, according to the gate driving signal Sga and the data driving signal Sda from the timing controller 232. Accordingly, the organic light emitting diode panel 210 displays a certain image.

Meanwhile, the organic light emitting diode panel 210 can include an organic light emitting layer. In order to display an image, a plurality of gate lines GL and data lines DL can be disposed in a matrix form in each pixel corresponding to the organic light emitting layer.

Meanwhile, the data driver 236 can output a data signal to the organic light emitting diode panel 210 based on a second DC power V2 from the second interface 231.

The power supply 290 can supply various power supplies to the gate driver 234, the data driver 236, the timing controller 232, and the like.

The current detector 510 can be configured to detect the current flowing in a sub-pixel of the organic light emitting diode panel 210. The detected current can be input to the processor 270 or the like, for a cumulative current calculation.

The processor 270 can be configured to perform each type of control of the display 180. For example, the processor 270 can control the gate driver 234, the data driver 236, the timing controller 232, and the like.

Meanwhile, the processor 270 can be configured to receive current information flowing in a sub-pixel of the organic light emitting diode panel 210 from the current detector 510.

In addition, the processor 270 can calculate the accumulated current of each subpixel of the organic light emitting diode panel 210, based on information of current flowing through the subpixel of the organic light emitting diode panel 210. The calculated accumulated current can be stored in the memory 240.

Meanwhile, the processor 270 can be configured to determine as burn-in, if the accumulated current of each sub-pixel of the organic light emitting diode panel 210 is equal to or greater than an allowable value.

For example, if the accumulated current of each subpixel of the OLED panel 210 is equal to or higher than 300000 A, the processor 270 can be configured to determine that a corresponding subpixel is a burn-in subpixel.

Meanwhile, if the accumulated current of each subpixel of the OLED panel 210 is close to an allowable value, the processor 270 can be configured to determine that a corresponding subpixel is a subpixel expected to be burn in.

Meanwhile, based on a current detected by the current detector 510, the processor 270 can be configured to determine that a subpixel having the greatest accumulated current is an expected burn-in subpixel.

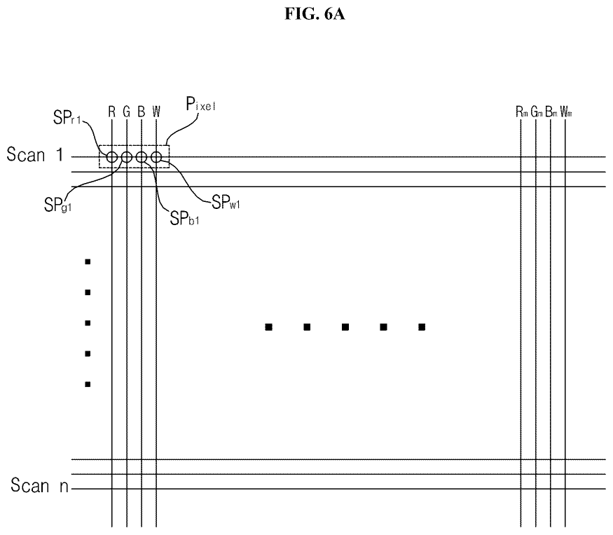

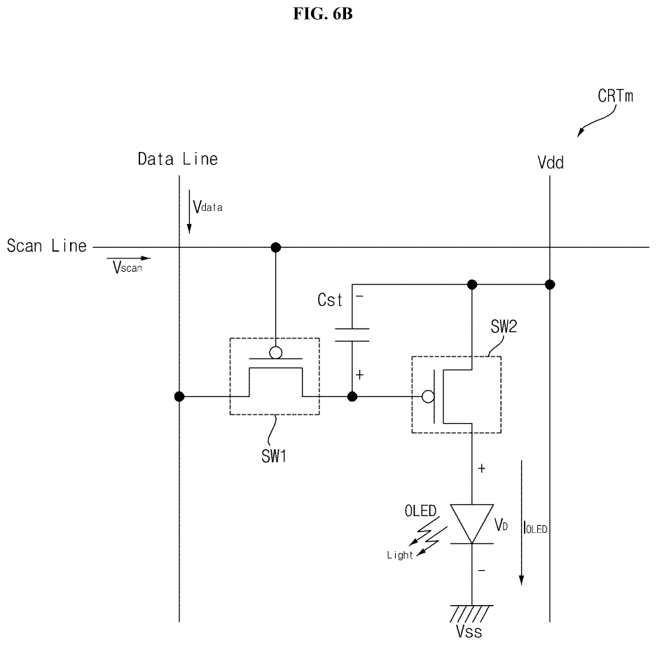

FIG. 6A and FIG. 6B are diagrams referred to in the description of an organic light emitting diode panel of FIG. 5.

Firstly, FIG. 6A is a diagram illustrating a pixel in the organic light emitting diode panel 210.

Referring to the figure, the organic light emitting diode panel 210 can include a plurality of scan lines Scan1 to Scann and a plurality of data lines R1, G1, B1, W1 to Rm, Gm, Bm, Wm intersecting the scan lines.

Meanwhile, a pixel (subpixel) is defined in an intersecting region of the scan line and the data line in the organic light emitting diode panel 210. In the figure, a pixel including sub-pixels SR1, SG1, SB1 and SW1 of RGBW is shown.

FIG. 6B illustrates a circuit of any one sub-pixel in the pixel of the organic light emitting diode panel of FIG. 6A.

Referring to the figure, an organic light emitting sub pixel circuit (CRTm) can include, as an active type, a scan switching element SW1, a storage capacitor Cst, a drive switching element SW2, and an organic light emitting layer (OLED).

The scan switching element SW1 is turned on according to the input scan signal Vdscan, as a scan line is connected to a gate terminal. in case in which it is turned on, the input data signal Vdata is transferred to the gate terminal of a drive switching element SW2 or one end of the storage capacitor Cst.

The storage capacitor Cst is formed between the gate terminal and the source terminal of the drive switching element SW2, and stores a certain difference between a data signal level transmitted to one end of the storage capacitor Cst and a DC power (VDD) level transmitted to the other terminal of the storage capacitor Cst.

For example, in case in which the data signal has a different level according to a Plume Amplitude Modulation (PAM) method, the power level stored in the storage capacitor Cst varies according to the level difference of the data signal Vdata.

For another example, in case in which the data signal has a different pulse width according to a pulse width modulation (PWM) method, the power level stored in the storage capacitor Cst varies according to the pulse width difference of the data signal Vdata.

The drive switching element SW2 is turned on according to the power level stored in the storage capacitor Cst. in case in which the drive switching element SW2 is turned on, the driving current (IOLED), which is proportional to the stored power level, flows in the organic light emitting layer (OLED). Accordingly, the organic light emitting layer OLED performs a light emitting operation.

The organic light emitting layer OLED can include a light emitting layer (EML) of RGBW corresponding to a subpixel, and can include at least one of a hole injecting layer (HIL), a hole transporting layer (HTL), an electron transporting layer (ETL), and an electron injecting layer (EIL). In addition, it can include a hole blocking layer, and the like.

Meanwhile, the subpixels emit a white light in the organic light emitting layer OLED. However, in the case of green, red, and blue subpixels, a subpixel is provided with a separate color filter for color implementation. That is, in the case of green, red, and blue subpixels, each of the subpixels further includes green, red, and blue color filters. Meanwhile, since a white subpixel outputs a white light, a separate color filter is not required.

Meanwhile, in the figure, it is illustrated that a p-type MOSFET is used for a scan switching element SW1 and a drive switching element SW2, but an n-type MOSFET or other switching element, such as a JFET, IGBT, SIC, or the like are also available.

Meanwhile, the pixel is a hold-type element that continuously emits light in the organic light emitting layer (OLED), after a scan signal is applied, during a unit display period, specifically, during a unit frame.

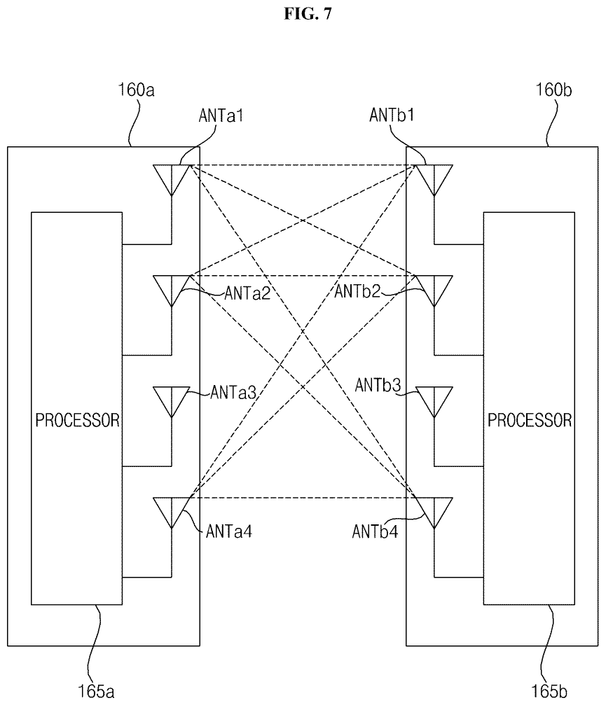

FIG. 7 is a diagram referred to in the description of a transceiver of FIG. 2 and a second transceiver.

Referring to the figure, the transceiver 160a can include 2*2-based multiple-input and multiple-output (MIMO) antennas ANTa1 to ANTa4 and a processor 165a.

The transceiver 160a can output beams for each sector based on the 2*2-based MIMO antennas ANTa1 to ANTa4.

The transceiver 160a can be configured to perform wireless communication based on the 802.11 ad/ay standard. Accordingly, media data can be stably transmitted wirelessly.

The processor 165a can be configured to perform control to transmit a first signal based on a beam having a first shape in which a sector is sequentially changed during a first period, receive a second signal based on a beam having the first shape from the display device 50 during a third period based on selection of the wireless media device 300 of the display device 50 during a second period, approve association with the display device 50 based on network address information in the second signal during a fourth period, transmit a third signal based on a beam having a second shape at an angle less than that of the first shape during a fifth period, and transmit wireless media to the display device 50 based on a beam having the second shape during a sixth period.

The processor 165a according to an embodiment of the present disclosure transmits, to the display device 50, a data frame including a preamble, a header, and media data through at least one transmission channel among a plurality of channels, and controls a preamble of a channel adjacent to the transmission channel, and the preamble of the transmission channel to be different from or orthogonal to each other. Accordingly, it is possible to reduce channel interference of adjacent channels during the wireless media transmission. Furthermore, it is possible to stably transmit media data during the wireless media transmission.

The processor 165a according to another embodiment of the present disclosure transmits, to the display device 50, a data frame including a preamble and media data through at least one transmission channel among a plurality of channels, and controls a sequence of data frames of the transmission channel to be different from or orthogonal to a sequence of data frames of a channel adjacent to the transmission channel. Accordingly, it is possible to reduce channel interference of adjacent channels during the wireless media transmission. Furthermore, it is possible to stably transmit the media data during the wireless media transmission.

Meanwhile, the second transceiver 160b can include a 2*2-based MIMO antennas ANTb1 to ANTb4 and a second processor 165b.

The second transceiver 160b can output beams for each sector based on the 2*2-based MIMO antennas ANTb1 to ANTb4.

The second transceiver 160b can be configured to perform wireless communication based on the 802.11 ad/ay standard.

The second processor 165b can be configured to perform control to receive the first signal based on the beam having the first shape in which a sector is sequentially changed during the first period, select the wireless media device 300 based on the first signal during the second period, transmit the second signal based on the beam having the first shape including network address information during the third period, approve association with the wireless media device 300 during the fourth period, receive the third signal based on the beam having the second shape at an angle less than that of the first shape during the fifth period, and display an image on the display based on reception of wireless media based on the beam having the second shape during the sixth period.

The processor 165b according to an embodiment of the present disclosure receives, from the display device 300, a data frame including a preamble, a header, and media data through at least one transmission channel among a plurality of channels, and controls a preamble of a channel adjacent to a reception channel to be different from or orthogonal to the preamble of the reception channel. Accordingly, it is possible to reduce channel interference of adjacent channels during wireless media reception. Furthermore, it is possible to stably receive the media data during the wireless media reception.

The second processor 165b according to another embodiment of the present disclosure receives, from the display device 300, a data frame including a preamble and media data through at least one reception channel among a plurality of channels, and controls a sequence of data frames of the reception channel to be different from or orthogonal to a sequence of data frames of a channel adjacent to the reception channel. Accordingly, it is possible to reduce channel interference of adjacent channels during the wireless media reception. Furthermore, it is possible to stably receive media data during the wireless media reception.

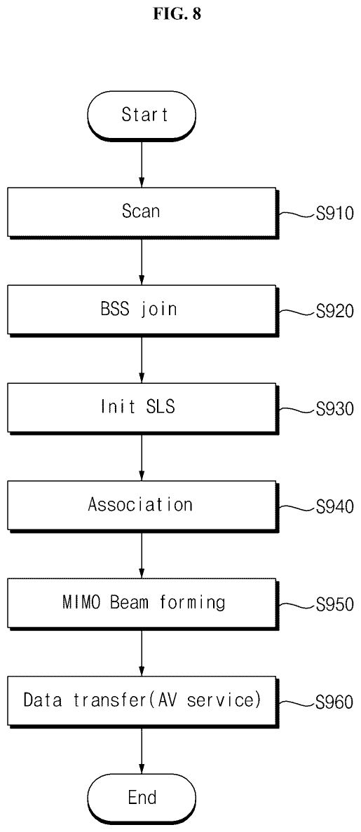

FIG. 8 is a flowchart illustrating an operation of an image display apparatus.

Referring to the figure, during the first period (S910), the transceiver 160a in the wireless media device 300 of the image display apparatus 100 transmits the first signal based on the beam having first shape in which a sector is sequentially changed. Meanwhile, the first period S910 can be referred to as a scan period.

During the second period (S920), the second transceiver 160b in the display device 50 of the image display apparatus 100 selects one beam from among a plurality of received beams. Meanwhile, the second period (S920) can be referred to as a basic service set (BSS) join period.

For example, during the second period (S920), the second transceiver 160b in the display device 50 can be configured to select a beam output from the wireless media device 300, rather than other wireless media devices.

Meanwhile, during the second period (S920), the second transceiver 160b in the display device 50 can extract a beacon signal in the first signal based on the beam having the first shape and roughly recognize position information of the wireless media device 300 based on the beacon signal.

Also, the second transceiver 160b in the display device 50 transmits the second signal based on the beam having the first shape. The second signal here can include information related to the second transceiver 160b. For example, the second signal can include sector information.

During the third period (S930) after the second period (S920), the transceiver 160a within the wireless media device 300 receives the second signal based on the beam having the first shape from the display device 50. Meanwhile, the third period S930 can be referred to as a sector level sweep (SLS) period.

Meanwhile, during the third period (S930), the transceiver 160a in the wireless media device 300 can be configured to select any one of a plurality of sectors.

For example, during the third period (S930), the transceiver 160a in the wireless media device 300 can be configured to select any one of the plurality of sectors based on sector information in the second signal.

During the fourth period (S940) after the third period (S930), the transceiver 160a in the wireless media device 300 approves association with the display device 50 based on the network address information (e.g., MAC address information) in the second signal. The fourth period (S940) can be referred to as an association period.

Meanwhile, during the fourth period (S940), the transceiver 160a in the wireless media device 300 can approve the association with the display device 50 based on the network address information and communication available channel information in the second signal.

During the fifth period (S950) after the fourth period (S940), the transceiver 160a in the wireless media device 300 transmits the third signal based on the beam having the second shape at an angle less than that of the first shape. The fifth period (S950) can be referred to as a MIMO beamforming period.

During the fifth period (S950), the transceiver 160a in the wireless media device 300 can be configured to select any one of a plurality of beams within the selected sector.

Also, during the fifth period (S950), the transceiver 160a in the wireless media device 300 can output the beam having the second shape having a beam width narrower than the first shape based on the selected sector.

During the sixth period (S960) after the fifth period (S950), wireless media is transmitted to the display device 50 based on the beam having the second shape. The sixth period (S960) can be referred to as a data transfer period.

Meanwhile, the transceiver 160a in the wireless media device 300 can be configured to determine whether an error occurs during wireless media transmission, and in case in which an error does not occur, the transceiver 160a in the wireless media device 300 can control the sixth period (S960) to be continuously performed, and in case in which an error occurs, the transceiver 160a in the wireless media device 300 can control the fifth period and the sixth period (S950 and S960) to be performed again, control the third period to the sixth period (S930 to S960) to be performed again, or control the first period to the sixth period (S930 to S960) to be performed again, selectively, depending on an error range. Accordingly, the error can be efficiently recovered depending on the error range.

Meanwhile, in case in which wireless media is received, the second transceiver 160b can control the fifth period and the sixth period (S950 and S960) to be performed again, control the third period to the sixth period (S930 to S960) to be performed again, or control the first period to the sixth period (S910 to S960) to be performed again, selectively, depending on an error range. Accordingly, an error can be efficiently recovered depending on the error range.

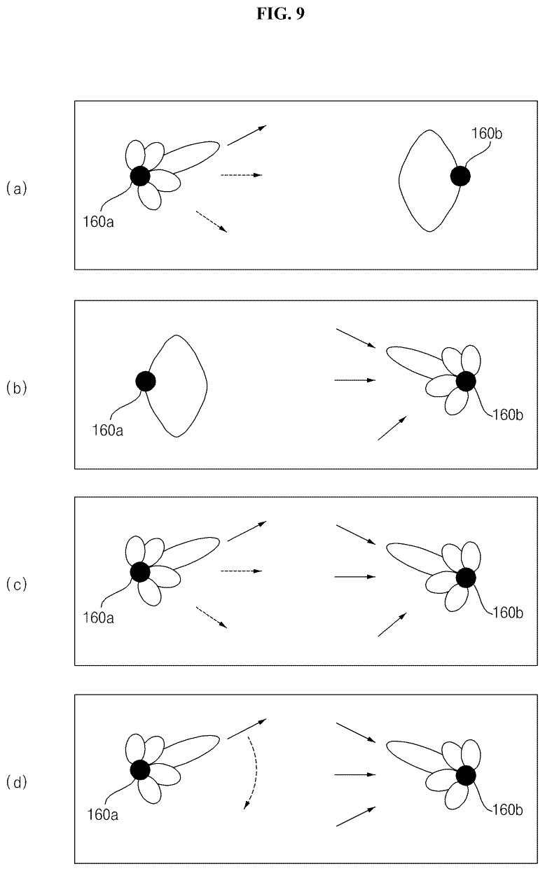

FIG. 9 is a diagram referred to as in the description of FIG. 8.

Referring to the figure, FIG. 9 is a diagram illustrating a beamforming processor.

First, (a) of FIG. 9 illustrates that, as in step 910 (S910 ), a beam having a first shape in which a sector is sequentially changed is output from the transceiver 160a. At this time, the second transceiver 160b can be configured to perform scanning.
(b) of FIG. 9 illustrates receiving of a plurality of beams by the second transceiver 160b.
(c) of FIG. 9 illustrates that a beam corresponding to any one sector among a plurality of beams is output from the transceiver 160a. In response to this, the second transceiver 160b receives the beam of the corresponding sector.
(d) of FIG. 9 illustrates that the second transceiver 160b performs beam tracking. The second transceiver 160b can be configured to select any one of a plurality of received beams based on beam strength and the like.

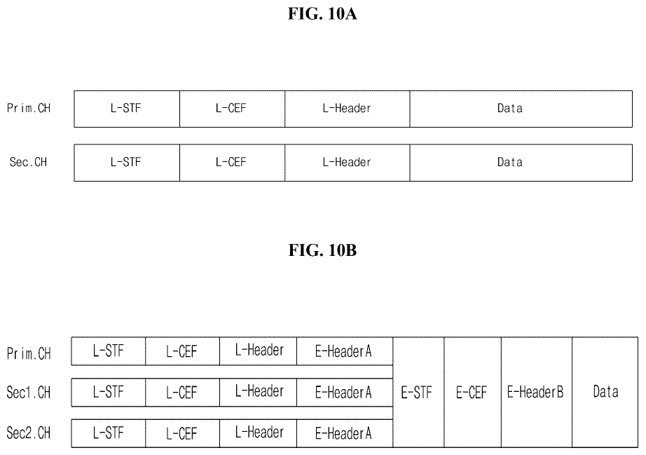

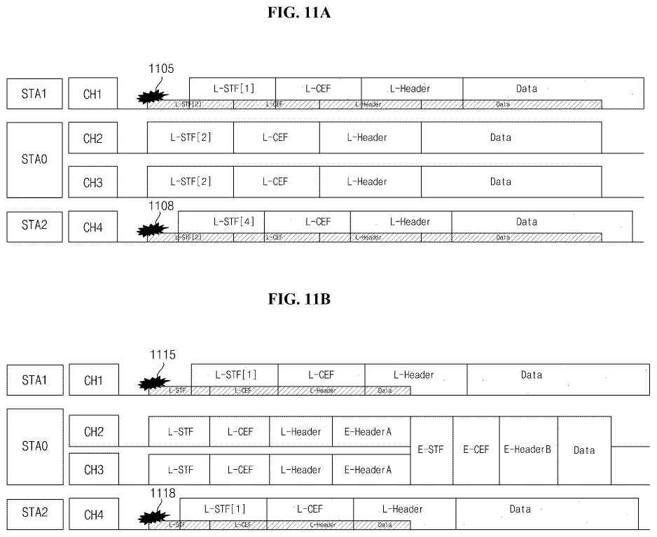

FIGS. 10A to 11B are diagrams referred to in the description of an operation of a wireless media device related to the present disclosure.

FIG. 10A illustrates an example of a data frame related to the present disclosure.

Referring to the figure, the data frame of FIG. 10A can correspond to a non-EDMG PPDU transmission mode-based data frame in an 802.11 ad/ay standard.

In particular, in the case of a duplicate mode transmission scheme, as illustrated in the figure, preambles, headers, and data in a primary channel and a secondary channel can be the same.

FIG. 10B illustrates another example of the data frame related to the present disclosure.

Referring to the figure, the data frame of FIG. 10B can correspond to an EDMG PPDU transmission mode-based data frame in the 802.11 ad/ay standard.

In particular, in the case of the duplicate mode transmission scheme, as illustrated in the figure, the preambles, the headers, and the data in the primary channel and the secondary channel can be the same.

FIG. 11A illustrates that an interference signal is generated in an adjacent channel when using the non-EDMG PPDU transmission mode-based data frame of FIG. 10A.

Referring to the figure, when the wireless media device 300 corresponding to STA0 uses two transmission channels CH2 and CH3 among a plurality of channels CH1 to CH4 according to a duplicate mode, a first external device (not illustrated) corresponding to STA1 can use CH1 adjacent to CH2 among two transmission channels, and a second external device (not illustrated) corresponding to STA2 can use CH4 adjacent to CH3 among two transmission channels.

Meanwhile, the first external device (not illustrated) or the second external device (not illustrated) can detect a preamble signal in CH1 and CH4 without data transmission due to data frames in two transmission channels CH2 and CH3.

Accordingly, unnecessary frame detection events 1105 and 1108 occur in the first external device (not illustrated) or the second external device (not illustrated), and a system level throughput decreases.

Furthermore, media transmission between the wireless media device 300 and the display device 50 is also affected due to adjacent channel interference.

FIG. 11B illustrates that the interference signal is generated in the adjacent channel when using the EDMG PPDU transmission mode-based data frame of FIG. 10B.

Referring to the figure, when the wireless media device 300 corresponding to STA0 uses two transmission channels CH2 and CH3 among a plurality of channels CH1 to CH4 according to a duplicate mode, a first external device (not illustrated) corresponding to STA1 can use CH1 adjacent to CH2 among two transmission channels, and a second external device (not illustrated) corresponding to STA2 can use CH4 adjacent to CH3 among two transmission channels.

Meanwhile, the first external device (not illustrated) or the second external device (not illustrated) can detect a preamble signal in CH1 and CH4 without data transmission due to data frames in two transmission channels CH2 and CH3.

Accordingly, unnecessary frame detection events 1115 and 1118 occur in the first external device (not illustrated) or the second external device (not illustrated), and the system level throughput decreases.

Furthermore, media transmission between the wireless media device 300 and the display device 50 is also affected due to adjacent channel interference.

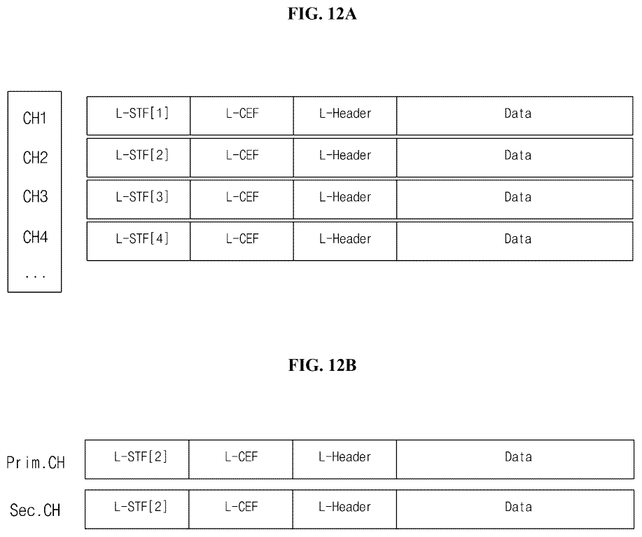

Accordingly, the present disclosure proposes a method for reducing channel interference of adjacent channels during wireless media transmission. This is described with reference to FIG. 12A or below.

FIGS. 12A and 12B are diagrams referred to in the description of an operation of a wireless media device according to an embodiment of the present disclosure.

First, FIG. 12A illustrates an example of a data frame according to an embodiment of the present disclosure.

Referring to the figure, the data frame of FIG. 12A can correspond to a data frame in the 802.11 ad/ay standard.

The data frame according to an embodiment of the present disclosure includes a preamble, a header, and media data.

The preamble can include training information and channel estimation information, the header can include baseband information, physical layer information, and identification information, and the data can include media data.

Specifically, the preamble can include a legacy-short training field (L-STF) corresponding to the training information, and a legacy-channel estimation field (L-CEF) corresponding to the channel estimation information. The header can include a legacy (L)-header.

In the present disclosure, in order to reduce adjacent channel interference, control is performed such that a preamble of a channel adjacent to a transmission channel is different from or orthogonal to a preamble of the transmission channel.

In the figure, a data frame including a preamble, a header, and data is illustrated in each of the plurality of channels CH1 to CH4, and in this case, training information in preambles for respective channels are L-STF[1], L-STF[2], L-STF[3], and L-STF[4], which are different patterns from each other, respectively.

In this case, it is preferable that L-STF[1], L-STF[2], L-STF[3], and L-STF[4] for respective channels are orthogonal to each other.

For example, L-STF[1] and L-STF[2] are orthogonal to each other, and a correlation is preferably 0. Similarly, it is preferable that L-STF[1] and L-STF[3] are orthogonal to each other, L-STF[1] and L-STF[4] are orthogonal to each other, L-STF[2] and L-STS[3] are orthogonal to each other, L-STF[2] and L-STF[4] are orthogonal to each other, and L-STF[3] and L-STF[4] are orthogonal to each other.

As such, since the training information in the preambles for the respective channels is different patterns and is orthogonal to each other, interference between adjacent channels does not occur, and therefore, channel interference of adjacent channels can be reduced. Furthermore, it is possible to stably transmit media data during the wireless media transmission.

Utilizing FIG. 12A, the wireless device 160a in the wireless media device 300 transmits, to the display device 50, a data frame including a preamble, a header, and media data through at least one transmission channel among a plurality of channels, and controls a preamble of a channel adjacent to the transmission channel to be different from or orthogonal to the preamble of the transmission channel. Accordingly, it is possible to reduce channel interference of adjacent channels during the wireless media transmission. Furthermore, it is possible to stably transmit the media data during the wireless media transmission.

Meanwhile, the transceiver 160a can control a preamble of a channel adjacent to the transmission channel, and a preamble of the transmission channel to be different from or orthogonal to each other during a data transfer period of transferring media data to the display device 50 among a first period to a sixth period of FIG. 8. Accordingly, it is possible to reduce channel interference of adjacent channels during the wireless media transmission.

Meanwhile, the transceiver 160a can control the preamble of the channel adjacent to the transmission channel, and the preamble of the transmission channel to be different from or orthogonal to each other during at least one period among the first period to the sixth period of FIG. 8. Accordingly, it is possible to reduce channel interference of adjacent channels during the wireless media transmission.

Meanwhile, the transceiver 160a can control a sequence of data frames of the transmission channel, and a sequence of data frames of a channel adjacent to the transmission channel to be different from or orthogonal to each other during at least one period among the first period to the sixth period of FIG. 8. Accordingly, it is possible to reduce channel interference of adjacent channels during the wireless media transmission.

For example, the transceiver 160a can control a sequence of data frames of the transmission channel to be different from or orthogonal to a sequence of data frames of a channel adjacent to the transmission channel during a scan period which is a first period S910 or an idle period after the scan period.

As another example, the transceiver 160a can control the sequence of the data frames of the transmission channel to be different from or orthogonal to the sequence of the data frames of the channel adjacent to the transmission channel during a basic service set configuration period which is a second period S920 or the idle period after the basic service set configuration period.

As yet another example, the transceiver 160a can control the sequence of the data frames of the transmission channel to be different from or orthogonal to the sequence of the data frames of the channel adjacent to the transmission channel during a sector level sweep period which is a third period S930 or the idle period after the sector level sweep period.

As still yet another example, the transceiver 160a can control the sequence of the data frames of the transmission channel to be different from or orthogonal to the sequence of the data frames of the channel adjacent to the transmission channel during a connection period which is a fourth period S940 or the idle period after the connection period.

As still yet another example, the transceiver 160a can control the sequence of the data frames of the transmission channel to be different from or orthogonal to the sequence of the data frames of the channel adjacent to the transmission channel during an MIMO beamforming period which is a fifth period S950 or the idle period after the MIMO beamforming period.

Meanwhile, during the data transfer period, when the non-enhanced directional multi-gigabit PHY protocol data unit (EDMG PPDU)-based data frame is transmitted through the transmission channel among the plurality of channels, the transceiver 160a can transmit a data frame including a legacy-short training field (L-STF), a legacy-channel estimation field (L-CEF), a legacy (L)-header, and media data, and control the L-STF in the preamble of the transmission channel to be different from or orthogonal to the L-STF in the preamble of the channel adjacent to the transmission channel. Accordingly, it is possible to reduce channel interference of adjacent channels during the wireless media transmission.

Meanwhile, the transceiver 160a can transmit a first data frame including the media data through the first channel among the plurality of channels during the data transfer period, and control the preamble of each of the second channel and the third channel adjacent to the first channel, and the preamble of the first channel to be different from or orthogonal to each other.

For example, the transceiver 160a can transmit the first data frame including the media data through the second channel CH2 among the plurality of channels during the data transfer period, and control the preamble of each of the first channel CH1 and the third channel CH3 adjacent to the second channel CH2, and the preamble of the second channel to be different from or orthogonal to each other. Accordingly, it is possible to reduce channel interference of adjacent channels during the wireless media transmission.

As another example, the transceiver 160a can transmit the first data frame including the media data through the third channel CH3 among the plurality of channels during the data transfer period, and control the preamble of each of the second channel CH2 and the fourth channel CH4 adjacent to the third channel CH3, and the preamble of the third channel to be different from or orthogonal to each other.

Meanwhile, during the data transfer period, when the non-enhanced directional multi-gigabit PHY protocol data unit (EDMG PPDU)-based data frame is transmitted through the first channel among the plurality of channels, the transceiver 160a can transmit the data frame including the legacy-short training field (L-STF), the legacy-channel estimation field (L-CEF), the legacy (L)-header, and the media data, and control the L-STF in the preamble of the first channel to be different from or orthogonal to the L-STFs in the preambles of the second channel and the third channel adjacent to the first channel. Accordingly, it is possible to reduce channel interference of adjacent channels during the wireless media transmission.

For example, during the data transfer period, the transceiver 160a can transmit a data frame including an L-STF[2], the L-CEF, the L-header, and the media data when transmitting the non-EDMG PPDU-based data frame through the second channel CH2 among the plurality of channels, and control the L-STF[2] in the preamble of the second channel to be different from or orthogonal to an L-STF[1] in the preamble of the first channel adjacent to the second channel and an L-STF[3] in the preamble of the third channel.

As another example, during the data transfer period, the transceiver 160a can transmit a data frame including the L-STF[3], the L-CEF, the L-header, and the media data when transmitting the non-EDMG PPDU-based data frame through the third channel CH3 among the plurality of channels, and control the L-STF[3] in the preamble of the third channel to be different from or orthogonal to the L-STF[2] in the preamble of the third channel adjacent to the third channel and an L-STF[4] in the preamble of the fourth channel.

Meanwhile, the data frame of FIG. 12A corresponds to a case of not the duplicate mode, and the duplicate mode will be described with reference to FIG. 12B.

FIG. 12B illustrates another example of the data frame according to an embodiment of the present disclosure.

Referring to the figure, the data frame of FIG. 12B can correspond to a data frame in the 802.11 ad/ay standard, and in particular, correspond to a data frame in the duplicate mode.

The transceiver 160a can duplicately transmit the first data frame including the media data through the first channel and the second channel among the plurality of channels during the data transfer period, and

In particular, in the case of the duplicate mode transmission scheme, as illustrated in the figure, the preambles, the headers, and the data in the primary channel and the secondary channel can be the same.

Meanwhile, the transceiver 160a can duplicately transmit a first data frame including the media data through the first channel and the second channel among the plurality of channels during the data transfer period, and control the preamble of third channel adjacent to the first channel to be different from or orthogonal to the preamble of the first channel, and control the preamble of the fourth channel adjacent to the second channel to be different from or orthogonal to the preamble of the second channel.

For example, the transceiver 160a can duplicately transmit the first data frame including the media data through the second channel CH2 and the third channel CH3 among the plurality of channels CH1 to CH4 during the data transfer period.

In this case, the second channel CH2 can be the primary channel, and the third channel CH3 can be the secondary channel.

Meanwhile, when duplicately transmitting the first data frame including the media data through the second channel CH2 and the third channel CH3 among the plurality of channels CH1 to CH4, the transceiver 160a can control the preamble of the first channel CH1 adjacent to the second channel CH2 to be different from or orthogonal to the second channel CH2, and control the preamble of the fourth channel CH4 adjacent to the third channel CH3 to be different from or orthogonal to the third channel CH3. Accordingly, it is possible to reduce channel interference of adjacent channels during the wireless media transmission.

Meanwhile, during the data transfer period, the transceiver 160a can transmit the data frame including the L-STF, the L-CEF, the L-header, and the media data when transmitting the non-EDMG PPDU-based data frame through the first channel and the second channel among the plurality of channels, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel. Accordingly, it is possible to reduce channel interference of adjacent channels during the wireless media transmission.

For example, during the data transfer period, the transceiver 160a can transmit the data frame including the L-STF[2], the L-CEF, the L-header, and the media data when transmitting the non-EDMG PPDU-based data frame through the second channel CH2 and the third channel CH3 among the plurality of channels CH1 to CH4, and control the L-STF[2] in the preamble of the second channel CH2 to be different from or orthogonal to the L-STF[1] in the preamble of the first channel adjacent to the second channel, and control the L-STF[2] in the preamble of the third channel CH3 to be different from or orthogonal to the L-STF[4] in the preamble of the fourth channel CH4 adjacent to the third channel. Accordingly, it is possible to reduce channel interference of adjacent channels during the wireless media transmission.

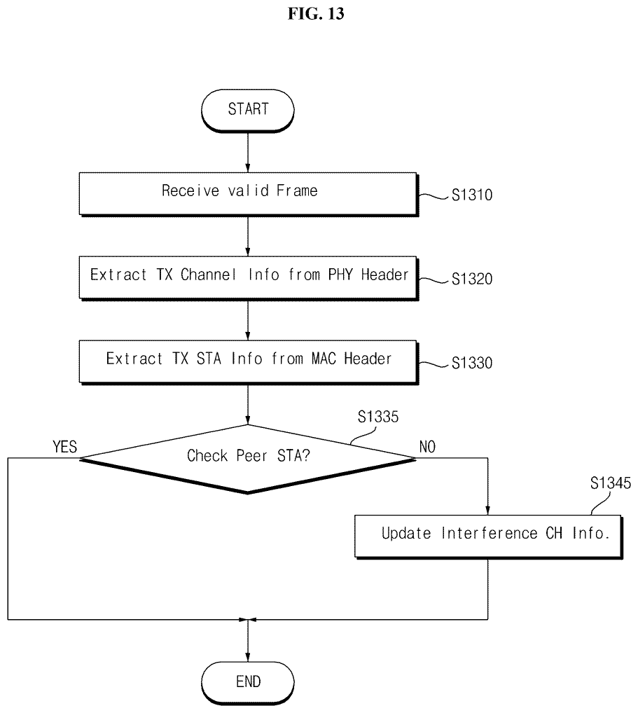

FIG. 13 is a flowchart illustrating an example of an operation of the wireless media device according to an embodiment of the present disclosure.

Referring to the figure, the transceiver 160a in the wireless media device 300 receives a data frame from at least one of the plurality of channels CH1 to CH4 through data frame detection (S1310).

Next, the transceiver 160a in the wireless media device 300 extracts transmission channel information from a preamble or a header in the received data frame (S1320).

For example, when the transmission channel information is included in the L-header in the frame data of FIG. 12A, the transceiver 160a in the wireless media device 300 extracts the transmission channel information in the L-header from the received frame data.

Next, the transceiver 160a in the wireless media device 300 extracts transmission station information from an MAC header in the received data frame (S1330).

The transmission station information in this case can include MAC address information, basic service set identifier (BSSID) information, transmitter address (TA)/receiver address (RA) information, source address (SA)/destination address (DA) information, and the like.

Next, the transceiver 160a in the wireless media device 300 determines whether a check on the display device 50, which is a transmission partner, is terminated (S1335), terminates a corresponding procedure if applicable, and updates interference channel information if not applicable (S1345).

For example, in FIG. 12A, when the second channel CH2 is the transmission channel, the transceiver 160a in the wireless media device 300 can update the first channel CH1 and the third channel CH3 as an interference channel or an adjacent channel.

Then, in FIG. 12A, when the second channel CH2 is the transmission channel, the transceiver 160a in the wireless media device 300 can control the L-STFs in the preambles in the first channel CH1 and the third channel CH3 to be different from or orthogonal to the L-STF of the second channels CH2. Accordingly, it is possible to reduce channel interference of adjacent channels during the wireless media transmission.

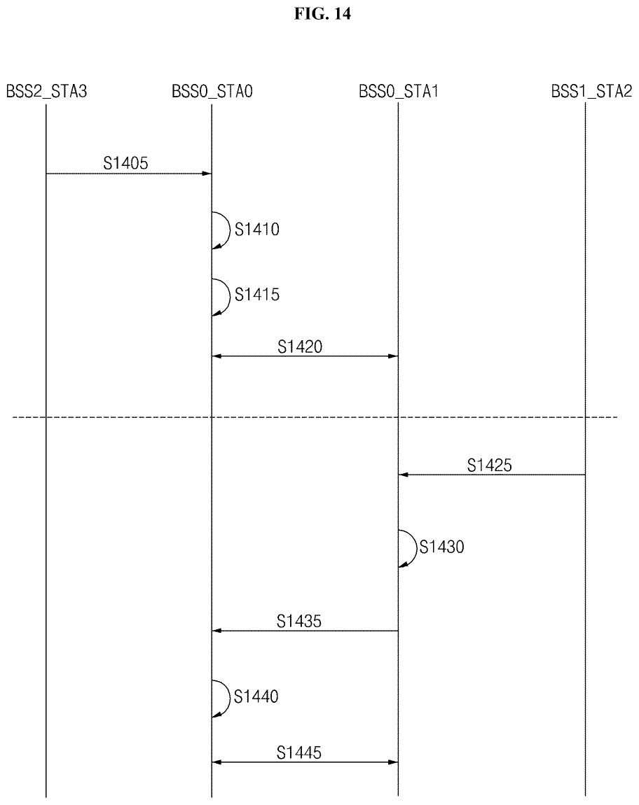

FIG. 14 is a flowchart illustrating another example of the operation of the wireless media device according to an embodiment of the present disclosure.

Referring to the figure, BSS2_STA3 can represent an adjacent first external device (not illustrated), BSS2_STA0 can represent the wireless media device 300, BSSO_STA1 can represent the display device 50, and BSS1_STA2 can represent an adjacent second external device (not illustrated).

First, the first external device (not illustrated) can transmit an interference signal to the wireless media device 300 (S1405). Correspondingly, the wireless media device 300 can receive the interference signal.

Next, the transceiver 160a in the wireless media device 300 performs data frame detection (S1410).

In this case, the transceiver 160a in the wireless media device 300 receives a data frame from at least one of the plurality of channels CH1 to CH4 and extracts interference channel information from a preamble or a header in the received data frame.

For example, when the interference channel information is included in the L-header in the frame data of FIG. 12A, the transceiver 160a in the wireless media device 300 extracts the interference channel information in the L-header from the received frame data.

Next, the transceiver 160a in the wireless media device 300 updates the extracted interference channel information (S1415).

Then, the transceiver 160a in the wireless media device 300 changes a transmission channel for communication with the display device 50 based on the extracted interference channel information (S1420).

For example, in FIG. 12A, when the interference channel is CH1, the transceiver 160a in the wireless media device 300 can change the transmission channel to CH2 or CH3 or CH4 for communication with the display device 50 based on the extracted interference channel information. Accordingly, it is possible to reduce channel interference of adjacent channels during the wireless media transmission.

Next, the second external device (not illustrated) can transmit an interference signal to the display device 50 (S1425). Correspondingly, the display device 50 can receive the interference signal.

Next, the second transceiver 160b in the display device 50 performs data frame detection (S1430).

In this case, the second transceiver 160b in the display device 50 receives a data frame from at least one of the plurality of channels CH1 to CH4 and extracts interference channel information from a preamble or a header in the received data frame.

For example, when the interference channel information is included in the L-Docket header in the frame data of FIG. 12A, the second transceiver 160b in the display device 50 extracts the interference channel information in the L-header from the received frame data.

Next, the second transceiver 160b in the display device 50 transmits the extracted interference channel information to the transceiver 160a in the wireless media device 300 (S1435).

The transceiver 160a in the wireless media device 300 receives the interference channel information from the second transceiver 160b in the display device 50 and updates the received interference channel information (S1440).

Then, the transceiver 160a in the wireless media device 300 changes the transmission channel for communication with the display device 50 based on the extracted interference channel information (S1440).

For example, when the interference channel by the second external device (not illustrated) is CH2, the transceiver 160a in the wireless media device 300 can change the transmission channel to CH3 or CH4 for communication with the display device 50 based on the extracted interference channel information. Accordingly, it is possible to reduce channel interference of adjacent channels during the wireless media transmission.

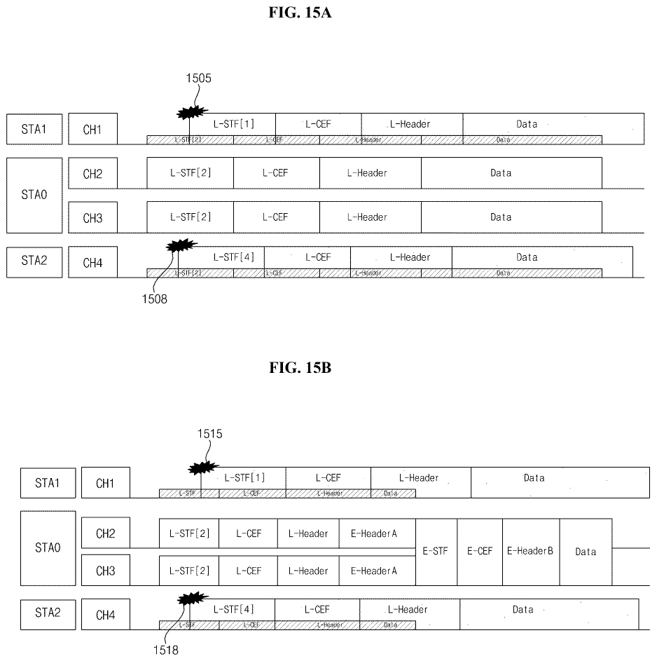

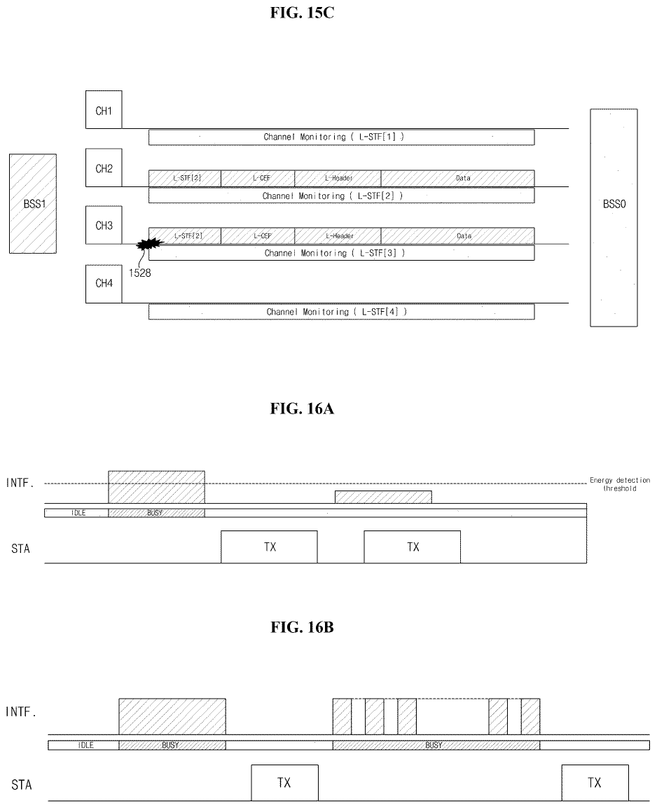

FIG. 15A illustrates non-EDMG PPDU transmission mode based data frame transmission according to an embodiment of the present disclosure.

Referring to the figure, when the wireless media device 300 corresponding to STA0 uses two transmission channels CH2 and CH3 among the plurality of channels CH1 to CH4 according to the duplicate mode, the first external device (not illustrated) corresponding to STA1 can use CH1 adjacent to CH2 among two transmission channels, and the second external device (not illustrated) corresponding to STA2 can use CH4 adjacent to CH3 among two transmission channels.

Meanwhile, the transceiver 160a in the wireless media device 300 according to an embodiment of the present disclosure controls preambles of a transmission channel and a channel adjacent to the transmission channel to be different from or orthogonal to each other.

In the figure, it is illustrated that training information in the preambles of two transmission channels CH2 and CH3 is L-STF[2], and the training information in the preambles of the remaining two channels CH1 and CH4 are L-STF[1] and L-STF[4].

In this case, patterns of L-STF[1] and L-STF[4] are preferably orthogonal to a pattern of L-STF[2].

Therefore, the first external device (not illustrated) or the second external device (not illustrated) does not perform frame detection on the transmission channels CH2 and CH3 despite the data frames in two transmission channels CH2 and CH3.

That is, since the first external device (not illustrated) or the second external device (not illustrated) is not a transmission channel thereof, a sequence of orthogonal adjacent channels is not detected.

Then, when the first external device (not illustrated) or the second external device (not illustrated) receives the frame data in the corresponding channel CH1 or CH4, respectively, the first external device (not illustrated) or the second external device (not illustrated) performs detection (1505 or 1508) of the corresponding frame data. Therefore, it is possible to reduce channel interference of adjacent channels during wireless media transmission, and it is possible to stably transmit media data during the wireless media transmission.

FIG. 15B illustrates EDMG PPDU transmission mode based data frame transmission according to an embodiment of the present disclosure.

Referring to the figure, when the wireless media device 300 corresponding to STA0 uses two transmission channels CH2 and CH3 among the plurality of channels CH1 to CH4 according to the duplicate mode, the first external device (not illustrated) corresponding to STA1 can use CH1 adjacent to CH2 among two transmission channels, and the second external device (not illustrated) corresponding to STA2 can use CH4 adjacent to CH3 among two transmission channels.

The EDMG PPDU transmission mode based data frame according to an embodiment of the present disclosure includes a preamble, a header, and media data.

As illustrated in FIG. 15A, the preamble can include a legacy-short training field (L-STF) corresponding to the training information, and a legacy-channel estimation field (L-CEF) corresponding to the channel estimation information. The header can include a legacy (L)-header.

Meanwhile, unlike FIG. 15, the preamble can further include an EDMG-short training field (E-STF) corresponding to the training information and an EDMG-channel estimation field (E-CEF) corresponding to the channel estimation information.

Meanwhile, the header can further include EDMG-header (E-header) A and E-header B in addition to the legacy (L)-header.

Meanwhile, during the data transfer period, the transceiver 160a can transmit a data frame including the L-STF, the L-CEF, the L-header, the E-header, and the media data when transmitting the EDMG PPDU-based data frame through the transmission channel among the plurality of channels, and control the L-STF in the preamble of the transmission channel to be different from or orthogonal to the L-STF in the preamble of the channel adjacent to the transmission channel.

Meanwhile, during the data transfer period, the transceiver 160a can transmit the data frame including the L-STF, the L-CEF, the L-header, the E-header, and the media data when transmitting the EDMG PPDU-based data frame through the first channel among the plurality of channels, and control the L-STF in the preamble of the first channel to be different from or orthogonal to the L-STF in the preamble of the third channel adjacent to the first channel, and control the L-STF in the preamble of the second channel to be different from or orthogonal to the L-STF in the preamble of the fourth channel adjacent to the second channel.

For example, during the data transfer period, the transceiver 160a can transmit the data frame including the L-STF[2], the L-CEF, the L-header, the E-header, and the media data when transmitting the EDMG PPDU-based data frame through the second channel and the third channel among the plurality of channels, and control the L-STF[2] in the preamble of the second channel CH2 to be different from or orthogonal to the L-STF[1] in the preamble of the first channel adjacent to the second channel CH2, and control the L-STF[2] in the preamble of the third channel CH3 to be different from or orthogonal to the L-STF[4] in the preamble of the fourth channel CH4 adjacent to the third channel CH3.

That is, the patterns of L-STF[1] and L-STF[4] are preferably orthogonal to the pattern of L-STF[2].

Therefore, the first external device (not illustrated) or the second external device (not illustrated) does not perform frame detection for the transmission channels CH2 and CH3 despite the data frames in two transmission channels CH2 and CH3.

That is, since the first external device (not illustrated) or the second external device (not illustrated) is not a transmission channel thereof, a sequence of orthogonal adjacent channels is not detected.

Then, when the first external device (not illustrated) or the second external device (not illustrated) receives the frame data in the corresponding channel CH1 or CH4, respectively, the first external device (not illustrated) or the second external device (not illustrated) performs detection (1515 or 1518) of the corresponding frame data. Therefore, it is possible to reduce channel interference of adjacent channels during wireless media transmission, and it is possible to stably transmit the media data during the wireless media transmission.

FIG. 15C illustrates another example of the non-EDMG PPDU transmission mode based data frame transmission according to an embodiment of the present disclosure.

Referring to the figure, the wireless media device 300 corresponding to BSS1 can perform media transmission to the display device 50 corresponding to SS0 by using some transmission channels among the plurality of channels CH1 to CH4.

Meanwhile, the transceiver 160a in the wireless media device 300 according to an embodiment of the present disclosure controls preambles of a transmission channel and a channel adjacent to the transmission channel to be different from or orthogonal to each other.

In the figure, training information in the preambles of the plurality of channels is illustrated to be different as L-STF[1], L-STF[2], L-STF[3], and L-STF[4], respectively.

Meanwhile, the transceiver 160a in the wireless media device 300 can perform media transmission to the display device 50 by using the third channel CH3 among the plurality of channels CH1 to CH4 as the transmission channel.

The transceiver 160a in the wireless media device 300 can perform channel monitoring for channel 1 CH1 and channel 4 CH4, and can perform the channel monitoring based on L-STF[1] and L-STF[4], respectively.

As illustrated in the figure, when no signal is received in channel 1 CH1 and channel 4 CH4, the transceiver 160a in the wireless media device 300 can terminate the channel monitoring for channel 1 CH1 and channel 4 CH4.

Meanwhile, when a predetermined data frame is received in the third channel CH3 among the plurality of channels CH1 to CH4, the transceiver 160a in the wireless media device 300 can perform the channel monitoring based on L-STF[3] corresponding to the third channel CH3.

In this case, the transceiver 160a in the wireless media device 300 does not perform data frame detection because the preamble in the received data frame as the L-STF[2] is different from and orthogonal to the reference L-STF[3]. Accordingly, efficient data frame detection and reception, are enabled, and furthermore, channel interference of adjacent channels can be reduced.

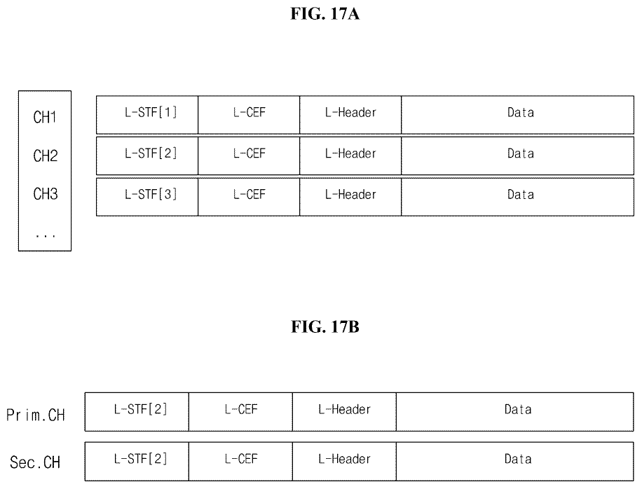

FIGS. 16A and 16B are diagrams referred to in the description of an operation of the wireless media device.

First, FIG. 16A illustrates an operation of a transceiver 160a in a physical carrier sense (CS)-based wireless media device 300.

Referring to the figure, when a level of an interference signal INTF is equal to or higher than a reference level, the transceiver 160a in the wireless media device 300 corresponding to STA determines that the channel is in a busy state rather than an idle state, and controls not to perform data transmission in a corresponding interval.

Meanwhile, when the level of the interference signal INTF is lower than the reference level, the transceiver 160a in the wireless media device 300 determines that the channel is in the idle state, and controls to perform the data transmission in a corresponding interval.

The figure illustrates that a transmission interval is divided into two intervals, there is no interference signal in a first transmission interval, and the interference signal is weak in a second transmission interval.

In this case, channel interference can occur due to an adjacent channel, but the transceiver 160a in the wireless media device 300 according to an embodiment of the present disclosure controls a preamble of a channel adjacent to a transmission channel, and a preamble of the transmission channel to be different from or orthogonal to each other. Accordingly, it is possible to reduce channel interference of adjacent channels during the wireless media transmission. Furthermore, it is possible to stably transmit media data during the wireless media transmission.

Next, FIG. 16B illustrates an operation of a transceiver 160a in a virtual carrier sense (CS)-based wireless media device 300.

The transceiver 160a in the wireless media device 300 corresponding to the STA determines that the channel is in the busy state rather than the idle state during an interval in which the interference signal INTF is generated, and controls not to perform data transmission in the corresponding interval.

Meanwhile, the figure illustrates that the interference signal INTF is continuously generated in the first interval and the interference signal INTF is repeatedly generated in the second interval.

That is, when the interference signal INTF is continuously generated or repeatedly generated, the transceiver 160a in the wireless media device 300 determines that the channel is in the busy state, and controls not to perform the data transmission in the corresponding interval.

Meanwhile, the transceiver 160a in the wireless media device 300 controls to perform the data transmission in an interval in which there is no interference signal INTF.

The figure illustrates that the transmission interval is divided into two intervals, and there is no interference signal in the first transmission interval and the second transmission interval. In this case, the channel interference due to the adjacent channel does not occur.

FIGS. 17A and 17B illustrate examples of data frames of various modes according to an embodiment of the present disclosure.

FIG. 17A illustrates an example of a data frame of a single mode.

Referring to the figure, the data frame according to an embodiment of the present disclosure can include an L-STF corresponding to training information, an L-CEF corresponding to channel estimation information, a header, and data.

Meanwhile, the transceiver 160a in the wireless media device 300 can control or set the L-STFs corresponding to the training information to be orthogonal to each other for each channel.

In the figure, for each of channels 1 to 3, the L-STF has a sequence in which L-STF[1], L-STF[2], and L-STF[3] are orthogonal to each other. Accordingly, it is possible to reduce channel interference of adjacent channels during the wireless media transmission.

FIG. 17B illustrates an example of a data frame of a duplicate mode.

Referring to the figure, the data frame according to an embodiment of the present disclosure can include an L-STF corresponding to training information, an L-CEF corresponding to channel estimation information, a header, and data.

Meanwhile, the transceiver 160a in the wireless media device 300 can set any one of the two transmission channels as the primary channel and the other one as the secondary channel, and control the L-STF[2], which is the same training information, to be transmitted.

Then, the transceiver 160a in the wireless media device 300 can control the L-STF corresponding to the training information of the channel adjacent to the two transmission channels to be orthogonal to L-STF[2]. Accordingly, it is possible to reduce channel interference of adjacent channels during the wireless media transmission.

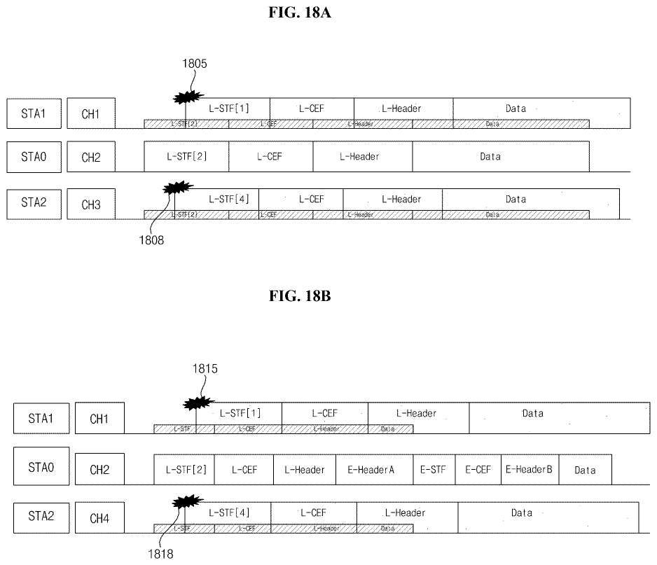

FIG. 18A illustrates non-EDMG PPDU transmission mode based data frame transmission in a single mode according to an embodiment of the present disclosure.

Referring to the figure, when the wireless media device 300 corresponding to STA0 uses the second channel CH2 among the plurality of channels CH1 to CH3 as the transmission channel according to the single mode, the first external device (not illustrated) corresponding to STA1 can use CH1 adjacent to the second channel CH2, and the second external device (not illustrated) corresponding to STA2 can use CH3 adjacent to the second channel CH2.

Meanwhile, the transceiver 160a in the wireless media device 300 according to an embodiment of the present disclosure controls preambles of a transmission channel and a channel adjacent to the transmission channel to be different from or orthogonal to each other.

In the figure, it is illustrated that the training information in the preamble of the second channel CH2 is L-STF[2], and the training information in the preambles of the other channels CH1 and CH4 are L-STF[1] and L-STF[4].

In this case, patterns of L-STF[1] and L-STF[4] are preferably orthogonal to a pattern of L-STF[2].

Therefore, the first external device (not illustrated) or the second external device (not illustrated) does not perform frame detection for the transmission channel CH2 despite the data frame in the second channel CH2.

That is, since the first external device (not illustrated) or the second external device (not illustrated) is not a transmission channel thereof, a sequence of orthogonal adjacent channels is not detected.

Then, when the first external device (not illustrated) or the second external device (not illustrated) receives the frame data in the corresponding channel CH1 or CH3, respectively, the first external device (not illustrated) or the second external device (not illustrated) performs detection (1805 or 1808) of the corresponding frame data. Therefore, it is possible to reduce channel interference of adjacent channels during wireless media transmission, and it is possible to stably transmit the media data during the wireless media transmission.

FIG. 18B illustrates EDMG PPDU transmission mode based data frame transmission in a single mode according to an embodiment of the present disclosure.

Referring to the figure, when the wireless media device 300 corresponding to STA0 uses the second channel CH2 among the plurality of channels CH1 to CH3 as the transmission channel according to the single mode, the first external device (not illustrated) corresponding to STA1 can use CH1 adjacent to the second channel CH2, and the second external device (not illustrated) corresponding to STA2 can use CH4 adjacent to the second channel CH2.

The EDMG PPDU transmission mode based data frame according to an embodiment of the present disclosure includes a preamble, a header, and media data.

Meanwhile, during the data transfer period, the transceiver 160a can transmit a data frame including the L-STF, the L-CEF, the L-header, the E-header, and the media data when transmitting the EDMG PPDU-based data frame through the transmission channel among the plurality of channels, and control the L-STF in the preamble of the transmission channel to be different from or orthogonal to the L-STF in the preamble of the channel adjacent to the transmission channel.

For example, during the data transfer period, the transceiver 160a can transmit the data frame including the L-STF[2], the L-CEF, the L-header, the E-header, and the media data when transmitting the EDMG PPDU-based data frame through the second channel CH2 among the plurality of channels, and control the L-STF[2] in the preamble of the second channel CH2 to be different from or orthogonal to the L-STF[1] in the preamble of the first channel adjacent to the second channel, and control the L-STF[2] in the preamble of the second channel CH2 to be different from or orthogonal to the L-STF[4] in the preamble of the fourth channel CH4 adjacent to the second channel CH2.

That is, the patterns of L-STF[1] and L-STF[4] are preferably orthogonal to the pattern of L-STF[2].

Therefore, the first external device (not illustrated) or the second external device (not illustrated) does not perform frame detection for the second channel CH2 despite the data frame in the second channel CH2.

That is, since the first external device (not illustrated) or the second external device (not illustrated) is not a transmission channel thereof, a sequence of orthogonal adjacent channels is not detected.

Then, when the first external device (not illustrated) or the second external device (not illustrated) receives the frame data in the corresponding channel CH1 or CH3, respectively, the first external device (not illustrated) or the second external device (not illustrated) performs detection (1815 or 1818) of the corresponding frame data. Therefore, it is possible to reduce channel interference of adjacent channels during wireless media transmission, and it is possible to stably transmit media data during the wireless media transmission.

While the embodiments of the present disclosure have been illustrated and described above, the present disclosure is not limited to the aforementioned specific embodiments, various modifications can be made by a person with ordinary skill in the technical field to which the present disclosure pertains without departing from the subject matters of the present disclosure that are claimed in the claims, and these modifications should not be appreciated individually from the technical spirit or prospect of the present disclosure.

1. A wireless media device comprising:
a signal processing device configured to process an image signal or an audio signal; and
a transceiver configured to wirelessly transmit a signal from the signal processing device to an external display device,
wherein the transceiver is configured to
transmit, to the display device, a data frame including a preamble, a header, and media data through at least one transmission channel among a plurality of channels,
in response to a level of an interference signal being equal to or higher than a reference level during a first interval of a data transfer period of transmitting the media data to the display device, not perform data transmission in the first interval, and
in response to an interference signal existing during a second interval of the data transfer period and the level of the interference signal being lower than the reference level,
control a preamble of a channel adjacent to the transmission channel, and a preamble of the transmissions channel to be orthogonal to each other.

2. (canceled)

3. The wireless media device of claim 1, wherein the transceiver is configured to
transmit a data frame including a legacy-short training field (L-STF), a legacy-channel estimation field (L-CEF), a legacy (L)-header, and the media data when a non-enhanced directional multi-gigabit PHY protocol data unit (EDMG PPDU)-based data frame is transmitted through the transmission channel among the plurality of channels during the data transfer period, and
control an L-STF in the preamble of the transmission channel to be orthogonal to an L-STF in the preamble of the channel adjacent to the transmission channel.

4. The wireless media device of claim 1, wherein the transceiver is configured to
transmit a data frame including the legacy-short training field (L-STF), the legacy-channel estimation field (L-CEF), the legacy (L)-header, an EDMG (E)-header, and the media data when an EDMG PPDU-based data frame is transmitted through the transmission channel among the plurality of channels during the data transfer period, and
control the L-STF in the preamble of the transmission channel to be orthogonal to the L-STF in the preamble of the channel adjacent to the transmission channel.

5. The wireless media device of claim 4, wherein the EDMG PPDU-based data frame further includes an EDMG-short training field (E-STF) and an EDMG-channel estimation field (E-CEF).

6. The wireless media device of claim 1, wherein the transceiver is configured to
transmit a first data frame including the media data through a first channel among the plurality of channels during the data transfer period, and
control a preamble of each of a second channel and a third channel adjacent to the first channel, and the preamble of the first channel to be orthogonal to each other.

7. The wireless media device of claim 6, wherein the transceiver is configured to
transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel among the plurality of channels during the data transfer period, and
control an L-STF in the preamble of the first channel to be orthogonal to L-STFs in the preambles of the second channel and the third channel adjacent to the first channel.

8. The wireless media device of claim 6, wherein the transceiver is configured to
transmit the data frame including the legacy-short training field (L-STF), the legacy-channel estimation field (L-CEF), the legacy (L)-header, an EDMG (E)-header, and the media data when the EDMG PPDU-based data frame is transmitted through the first channel among the plurality of channels during the data transfer period, and
control the L-STF in the preamble of the first channel to be orthogonal to the L-STF in the preamble of the channel adjacent to the first channel.

9. The wireless media device of claim 1, wherein the transceiver is configured to
transmit a first data and a second data frame including the media data through the first channel and the second channel among the plurality of channels during the data transfer period, and
control a preamble of a third channel adjacent to the first channel to be orthogonal to the preamble of the first channel, and
control a preamble of a fourth channel adjacent to the second channel to be orthogonal to the preamble of the second channel.

10. The wireless media device of claim 9, wherein the transceiver is configured to
transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel and the second channel among the plurality of channels during the data transfer period, and
control the L-STF in the preamble of the first channel to be orthogonal to the L-STF in the preamble of the third channel adjacent to the first channel, and
control the L-STF in the preamble of the second channel to be orthogonal to the L-STF in the preamble of the fourth channel adjacent to the second channel.

11. The wireless media device of claim 9, wherein the transceiver is configured to
transmit the data frame including the legacy-short training field (L-STF), the legacy-channel estimation field (L-CEF), the legacy (L)-header, an EDMG (E)-header, and the media data when the EDMG PPDU-based data frame is transmitted through the first channel among the plurality of channels during the data transfer period, and
control the L-STF in the preamble of the first channel to be orthogonal to the L-STF in the preamble of the third channel adjacent to the first channel, and
control the L-STF in the preamble of the second channel to be orthogonal to the L-STF in the preamble of the fourth channel adjacent to the second channel.

12. The wireless media device of claim 1, wherein the transceiver is configured to
transmit the first data frame including the media data through the first channel and the second channel among the plurality of channels during the data transfer period, and control the preamble of the third channel adjacent to the first channel to be orthogonal to the preamble of the first channel, and
control the preamble of the fourth channel adjacent to the second channel to be orthogonal to the preamble of the second channel.

13. The wireless media device of claim 12, wherein the transceiver is configured to
transmit the data frame including the legacy-short training field (L-STF), the legacy-channel estimation field (L-CEF), the legacy (L)-header, and the media data when the non-enhanced directional multi-gigabit PHY protocol data unit (EDMG PPDU)-based data frame is transmitted through the first channel and the second channel among the plurality of channels during the data transfer period, and
control the L-STF in the preamble of the first channel to be orthogonal to the L-STF in the preamble of the third channel adjacent to the first channel, and control the L-STF in the preamble of the second channel to be orthogonal to the L-STF in the preamble of the fourth channel adjacent to the second channel.

14. The wireless media device of claim 12, wherein the transceiver is configured to
transmit the data frame including the legacy-short training field (L-STF), the legacy-channel estimation field (L-CEF), the legacy (L)-header, the EDMG (E)-header, and the media data when the EDMG PPDU-based data frame is transmitted through the first channel among the plurality of channels during the data transfer period, and
control the L-STF in the preamble of the first channel to be orthogonal to the L-STF in the preamble of the third channel adjacent to the first channel, and
control the L-STF in the preamble of the second channel to be orthogonal to the L-STF in the preamble of the fourth channel adjacent to the second channel.

15. The wireless media device of claim 1, wherein the transceiver is configured to
transmit a first signal based on a beam having a first shape in which a sector is sequentially varied during a first period, receive a second signal based on the beam having the first shape from the display device during a third period based on selection of the wireless media device of the display device during a second period, approve association with the display device based on network address information in the second signal during a fourth period, transmit a third signal based on a beam having a second shape at an angle smaller than that of the first shape during a fifth period, and transmit the media data to the display device based on the beam having the second shape during a sixth period, and
control the preamble of the channel adjacent to the transmission channel, and the preamble of the transmission channel to be orthogonal to each other during at least one period among the first period to the sixth period.

16. A wireless media device comprising:
a signal processing device configured to process an image signal or an audio signal; and
a transceiver configured to wirelessly transmit a signal from the signal processing device to an external display device,
wherein the transceiver is configured to
transmit, to the display device, a data frame including a preamble and media data through at least one transmission channel among a plurality of channels,
in response to a level of an interference signal being equal to or higher than a reference level during a first interval of a data transfer period of transmitting the media data to the display device, not perform data transmission in the first interval, and
in response to an interference signal existing during a second interval of the data transfer period and the level of the interference signal being lower than the reference level,
control a sequence of the data frame of the transmission channel, and a sequence of a data frame of a channel adjacent to the transmission channel to be orthogonal to each other.

17. The wireless media device of claim 16, wherein the transceiver is configured to
transmit a first signal based on a beam having a first shape in which a sector is sequentially varied during a first period, receive a second signal based on the beam having the first shape from the display device during a third period based on selection of the wireless media device of the display device during a second period, approve association with the display device based on network address information in the second signal during a fourth period, transmit a third signal based on a beam having a second shape at an angle smaller than that of the first shape during a fifth period, and transmit the media data to the display device based on the beam having the second shape during a sixth period, and
control the sequence of the data frame of the transmission channel, and the sequence of the data frame of the channel adjacent to the transmission channel to be orthogonal to each other during at least one period among the first period to the sixth period.

18. An image display apparatus comprising:
a display device; and
a wireless media device,
wherein the wireless media device comprises:
a signal processing device configured to process an image signal or an audio signal; and
a transceiver configured to wirelessly transmit a signal from the signal processing device to an external display device,
wherein the transceiver is configured to
transmit, to the display device, a data frame including a preamble, a header, and media data through at least one transmission channel among a plurality of channels,
in response to a level of an interference signal being equal to or higher than a reference level during a first interval of a data transfer period of transmitting the media data to the display device, not perform data transmission in the first interval, and
in response to an interference signal existing during a second interval of the data transfer period and the level of the interference signal being lower than the reference level, control a preamble of a channel adjacent to the transmission channel, and a preamble of the transmissions channel to be orthogonal to each other.

19. The image display apparatus of claim 18, wherein the transceiver is configured to
transmit a data frame including a legacy-short training field (L-STF), a legacy-channel estimation field (L-CEF), a legacy (L)-header, and the media data when a non-enhanced directional multi-gigabit PHY protocol data unit (EDMG PPDU)-based data frame is transmitted through the transmission channel among the plurality of channels during the data transfer period, and
control an L-STF in the preamble of the transmission channel to be orthogonal to an L-STF in the preamble of the channel adjacent to the transmission channel.

20. The image display apparatus of claim 18, wherein the transceiver is configured to
transmit a data frame including the legacy-short training field (L-STF), the legacy-channel estimation field (L-CEF), the legacy (L)-header, an EDMG (E)-header, and the media data when an EDMG PPDU-based data frame is transmitted through the transmission channel among the plurality of channels during the data transfer period, and
control the L-STF in the preamble of the transmission channel to be orthogonal to the L-STF in the preamble of the channel adjacent to the transmission channel.
